(19) United States
(12) Patent Application Publication
(10) Pub. No.: US 2024/0037182 A1
(43) Pub. Date: Feb. 1, 2024

(54) CONCURRENT MATRIX COMPUTATIONS USING SPLIT MATRICES WITH MULITIPLE STAGE PROCESSORS

(71) Applicant: SambaNova Systems, Inc., Palo Alto, CA (US)

(72) Inventors: Pramod NATARAJA, San Jose, CA (US); Raghu PRABHAKAR, San Jose, CA (US)

(73) Assignee: SambaNova Systems, Inc., Palo Alto, CA (US)

(21) Appl. No.: 18/378,293

(22) Filed: Oct. 10, 2023

Related U.S. Application Data
(63) Continuation of application No. 18/105,695, filed on Feb. 3, 2023.
(60) Provisional application No. 63/307,593, filed on Feb. 7, 2022.
(60) Provisional application No. 63/307,594, filed on Feb. 7, 2022.
(60) Provisional application No. 63/307,604, filed on Feb. 7, 2022.

(51) Int. Cl. G06F 17/16

(52) U.S. Cl. CPC G06F 17/16

(57) ABSTRACT

In a method, based on a left side matrix and a right side matrix having a shared dimension, a first Multiply Accumulate Arithmetic Logic Unit (MACC ALU) receives elements of a row of a first column-split matrix and elements of a column of a first column-split matrix. A second MACC ALU receives elements of a row of the second column-split matrix and elements of a column of the second row-split matrix. The first and a second column-split matrices comprise columns of the left side matrix and the first and second row-split matrices comprise rows of the right side matrix. The first and second MACC ALU concurrently compute partial dot products of the column and row elements and the second MACC ALU computes a sum of the partial dot products. A computing system can include the MACC ALUs in a matrix processing unit and can implement the method.

### PRIORITY BENEFIT CLAIM

This application is a continuation of U.S. Non-Provisional patent application Ser. No. 18/105,695, filed Feb. 3, 2023, titled “Exploiting Shared Dimensions In Matrix Computations”, which is incorporated by reference herein in its entirety.

This application claims the benefit of U.S. Provisional Patent Application No. 63/307,593 filed Feb. 7, 2022, which is incorporated by reference herein in its entirety.

This application claims the benefit of U.S. Provisional Patent Application No. 63/307,594 filed Feb. 7, 2022, which is incorporated by reference herein in its entirety.

This application claims the benefit of U.S. Provisional Patent Application No. [63/307,604 filed Feb. 7, 2022, which is incorporated by reference herein in its entirety.

### INCORPORATIONS

The following are incorporated by reference for all purposes as if fully set forth herein:
Prabhakar et al., “Plasticine: A Reconfigurable Architecture for Parallel Patterns,” ISCA '17, Jun. 24-28, 2017, Toronto, ON, Canada;
U.S. patent application Ser. No. 16/239,252, filed Jan. 3, 2019, entitled “VIRTUALIZATION OF A RECONFIGURABLE DATA PROCESSOR,” (Attorney Docket No. SBNV 1000-1); and,
U.S. patent application Ser. No. 16/922,975, filed Jul. 7, 2020, entitled “RUNTIME VIRTUALIZATION OF RECONFIGURABLE DATA FLOW RESOURCES,” (Attorney Docket No. SBNV 1026-1).

### FIELD OF THE TECHNOLOGY

The technology disclosed relates to computing systems for executing data parallel and DP computing applications. In particular, the technology disclosed relates to executing matrix computations in data parallel computing systems. Some such systems can employ reconfigurable processors, such as Coarse-Grain Reconfigurable Processors (CGRPs) to perform matrix computations.

### BACKGROUND

The present disclosure relates to computing systems for executing data parallel and/or DP computing applications, such as in machine learning and neural networks. The disclosure further relates to methods and structures of a computing system to perform matrix computations such as computing dot products of matrices. Such computations can be included in machine learning and/or neural networks. Computing systems of the present disclosure include computing systems utilizing reconfigurable processing architectures, such as computing systems comprising Coarse-Grained Reconfigurable Processors (CGRPs).

### SUMMARY

A Matrix Processing Unit (MPU) of a computing system comprises Multiply Accumulate (MACC) Arithmetic Logic Units (ALUs). A left side matrix and a right side matrix have a shared dimension, the left side matrix comprising the shared dimension number of columns and the right side matrix comprising the shared dimension number of rows.

In a method of computing dot products of the left side matrix and the right side matrix, based on the left side matrix and the right side matrix having the shared dimension, a first MACC ALU receives column elements of a row of a first column-split matrix and row elements of a column of a first row-split matrix. a first column-split matrix comprises a first number of columns among columns of the left side matrix, and the first row-split matrix comprising the first number of rows among rows of the right side matrix.

In the method, a second MACC ALU receives column elements of a row of a second column-split matrix and row elements of a column of a second row-split matrix. The second column-split matrix comprises a second number of columns among the shared dimension number of columns of the left side matrix, and the second row-split matrix comprises the second number of rows among the shared dimension number of rows of the right side matrix.

The first MACC ALU computes a first partial dot product comprising a sum of products of elements among the column elements of the row of the first column-split matrix multiplied by corresponding elements among the row elements of the column of the first row-split matrix. Concurrently, the second MACC ALU computes a second partial dot product comprising a sum of products of elements among the column elements of the row of the second column-split matrix multiplied by elements among the row elements of the column of the second row-split matrix. The second MACC ALU computes a dot product comprising a sum of the first partial dot product and the second partial dot product.

A computing system can comprise the MPU, MACC ALUs, and an adder, and the MPU, MACC ALUs, and the adder can perform the method.

### BRIEF DESCRIPTION OF THE DRAWINGS

The drawings included in the present disclosure are incorporated into, and form part of, the specification. They illustrate implementations of the present disclosure (hereinafter, “the disclosure) and, along with the description, serve to explain the principles of the disclosure. The drawings are intended to be only illustrative of certain implementations and are not intended to limit the disclosure.

FIG. 1 illustrates an example of splitting matrices based on a shared dimension, according to elements of the disclosure.

FIG. 2A illustrates an example multiply accumulate processing element, according to elements of the disclosure.

FIG. 2B illustrates an example shared dimension matrix processor, according to elements of the disclosure.

FIG. 3 illustrates an example method to perform matrix computations based on a shared matrix dimension, according to elements of the disclosure.

FIG. 4 illustrates a second example method to perform matrix computations based on a shared matrix dimension, according to elements of the disclosure.

FIG. 5 illustrates an alternative example shared dimension matrix processor, according to elements of the disclosure.

### DETAILED DESCRIPTION

Aspects of the present disclosure (hereinafter, “the disclosure”) relate to methods of performing matrix computations in computing systems. More particular aspects relate to improving parallelism of matrix computations and reducing processing cycles times computing systems by exploiting shared dimensions of matrices. As will be seen from a discussion of techniques and structures of the disclosure, implementations of the disclosure (hereinafter, “implementations”) can perform matrix computations more efficiently and with higher degrees of parallelism by exploiting shared dimensions of two multiplicand matrices in matrix computations.

Aspects of the disclosure can also particularly apply to processors of data parallel (DP) computing systems, such as Central Processing Unit (CPUs), Graphics Processing Units (GPUs), Field Programmable Gate Arrays (FPGAs), and Digital Signal Processors (DSPs). Certain aspects of the disclosure relate to performing tensor and/or matrix computations in computing systems utilizing reconfigurable processor architectures, such as computing systems utilizing Coarse-Grain Reconfigurable Processors (CGRPs), and/or reconfigurable Application Specific Integrated Circuits (ASICs) or Application Specific Instruction-set Processors (ASIP).

Implementations that are not mutually exclusive are taught to be combinable. One or more features of an implementation can be combined with other implementations. The disclosure in some instances repeats references to these options. However, omission from some implementations recitations that repeat these options should not be taken as limiting the combinations taught in the preceding sections—these recitations are hereby incorporated forward by reference into each of the following implementations.

Particular expressions of the disclosure will be understood to have the following operative meanings:
The phrases “at least one”; “one or more”; and “and/or” are to be understood as open-ended expressions that operate both conjunctively and disjunctively. For example, each of the expressions “at least one of A, B, and C”, “at least one of A, B, or C”, “one or more of A, B, and C”, “one or more of A, B, or C”, and “one or more of A, B, and/or C” means A alone, B alone, C alone, A and B together, A and C together, B and C together, or A, B, and C together.
The term “a” or “an” entity refers to one or more of that entity. As such, the terms “a”/“an”, “one or more”, and “at least one” can be used interchangeably herein.
The terms “comprising”, “including”, and “having” can be used interchangeably herein.

As used herein, “incorporated subject matter” refers, collectively, to subject matter disclosed, and/or otherwise encompassed, among the disclosures incorporated herein by reference. For purposes of illustrating the disclosure, but not intended to limit implementations, various terms of the disclosure are drawn from the incorporated subject matter. As used herein, unless expressly stated otherwise, such terms as may be found in the incorporated subject matter have the same meanings, herein, as their meanings in their respective incorporated disclosures.

Aspects of the disclosure can be appreciated through a discussion of example implementations and/or applications of methods and/or systems. However, such examples are for purposes of illustrating the disclosure. It should be understood that the intention is not to limit the disclosure to the example implementations described herein, but to encompass all modifications, equivalents, and alternatives falling within the spirit and scope of the disclosure. Thus, the disclosure is not intended to be limited to the implementations shown but is to be accorded the widest scope consistent with the principles and features disclosed herein. Various modifications to the disclosed examples will be readily appreciated by those of ordinary skill in the art, and the general principles defined herein may be applied to other implementations without departing from the spirit and scope of the disclosure.

Turning now to more particular aspects of the disclosure, DP computing applications can comprise computations that can be executed concurrently, in parallel, among a plurality of computational elements (processors and/or programs executing on processors, of a DP computing system). Examples of such DP applications include machine learning (ML) and deep machine learning (DML) methods of Artificial Intelligence (AI) applications; image processing; stream processing (e.g., processing of streaming video and/or audio data); natural language processing (NLP); and/or recommendation engines.

DP computing systems can comprise reconfigurable processing elements (reconfigurable processors, or “RPs”) particularly designed and/or configured to efficiently perform DP computing applications. Reconfigurable processors, such as field programmable gate arrays FPGAs and/or CGRP-based processors, can be configured to implement a variety of computational and/or data transfer functions more efficiently or faster than might be achieved using a general-purpose processor executing a computer program.

Prabhakar, et al., “Plasticine: A Reconfigurable Architecture for Parallel Patterns,” ISCA '17, Jun. 24-28, 2017, Toronto, ON, Canada, (hereinafter, “Prabhakar”) describes example CGRPs and, systems utilizing such CGRPs. U.S. Nonprovisional patent application Ser. No. 16/239,252, “VIRTUALIZATION OF A RECONFIGURABLE DATA PROCESSOR”, to Grohoski, et al, (hereinafter, “Grohoski”), and U.S. Nonprovisional patent application Ser. No. 16/922,975, “RUNTIME VIRTUALIZATION OF RECONFIGURABLE DATA FLOW RESOURCES”, to Kumar, et al, (hereinafter, “Kumar”), both incorporated herein by reference, illustrate additional example implementations of CGRPs and DP systems utilizing CGRPs. As used herein, the term “CGRP” to processors based on coarse-grain reconfigurable architectures and, interchangeably, to a hardware implementation—such as an integrated circuit, chip, or module—of a CGRP. In implementations, systems based on, and/or incorporating,

Owing to their dynamic reconfigurability and the potential to incorporate many hundreds or even thousands of CGRPs in a computation system, DP computing systems can particularly take advantage of CGRPs to improve computing performance. Accordingly, aspects of the disclosure relate to methods and systems utilizing reconfigurable DP resources, such as resources of a CGRP. However, the disclosure is not necessarily limited to computing systems utilizing CGRPs and it will be appreciated by one of ordinary skill in the art that computing systems can employ processing elements other than CGRPs (e.g., CPUs, FPGAs, GPUs, etc.) and remain within the scope and spirit of the disclosure.

As used herein, the term “reconfigurable DP system (RDS)” refers to a computing system that can utilize reconfigurable processing resources, such as CGRPs, to perform operations of DP applications. Owing to reconfigurability, reconfigurable DP systems can perform these operations more efficiently than systems comprising fixed or non-reconfigurable resources. As also used herein, the term “application” refers to any computing application (e.g., software program), and/or computing system, that utilizes an RDS, to perform algorithms and/or computations of the application. An application can execute, for example, on a processor included in, or coupled to, an RDS.

Kumar illustrates a DP system (e.g., an RDS) comprising user applications, programming libraries (e.g., deep learning frameworks), a software development kit, computation graphs associated with user applications, compilers, execution files that can specify operations of a user application to perform using resources (reconfigurable data flow resources) of the DP system, and host and runtime processors. User applications can comprise data parallel and/or DP applications. As illustrated by the examples of Kumar an RDS can comprise a plurality of physical racks each comprising one or more compute nodes (hereinafter, for brevity, “nodes”).

In the examples of Kumar a host and runtime processors can, for example, facilitate compiling a DP application, determining particular RDS resources to execute the application, and managing execution of the RDS resources in performing operations of the application. In the examples of Kumar a node can comprise a host processor, a runtime processor, and, more generally, reconfigurable processors (“RPs”), such as CGRPs. A runtime processor can include kernel drivers and/or a user space library (e.g., a library of programs a user can include, or can invoke, in a DP application and that can execute in a user space of a runtime processor).

In implementations, an RP can comprise reconfigurable processing elements with reconfigurable interconnections. Using the examples of Prabhakar, Grohoski, and Kumar hardware implementations of an RP can comprise pattern compute units (PCUs), pattern memory units (PMUs), arrays of PCUs and/or PMUs (“tiles”), networks of tiles, and/or network interfaces. The hardware implementations can comprise one or more Integrated Circuits (ICs). As used herein, the term “chip” refers to an IC (or, combination of ICs) that can embody elements of a CGRP. A chip can typically be packaged in a chip module (e.g., a single chip module, “SCM” or, alternatively, a multi-chip module, “MCM”).

As illustrated by Grohoski and Kumar, a reconfigurable dataflow unit (RDU) of a DP system can comprise a dynamically reconfigurable hardware resource of the system that includes processing elements (e.g., RPs) to perform operations of DP applications. In the examples of Grohoski and Kumar an RDU can comprise a set of processing elements (e.g., one or more RPs), I/O interfaces to communicate among processors of differing RDUs, and, optionally, a memory. In the examples of Kumar and Grohoski an RDU can, comprise other than simply computational elements (e.g., processors, such as PCUs) and/or memories (e.g., PMUs), such as clock circuits, control circuits, switches and/or switching circuits, interconnection interface circuits (e.g., processor, memory, I/O bus, and/or network interface circuits, etc. Kumar also illustrates that an RDU can include virtualization logic and/or, RP configuration logic.

For purposes of illustrating the disclosure, but not intended to limit implementations, the disclosure occasionally refers to the example of an RDU comprising RPs of Grohoski and Kumar to illustrate a reconfigurable processing element for executing operations (e.g., computations and/or data transfer) of DP applications, such as matrix computations of DP applications. However, it will be appreciated by one of ordinary skill in the art that a processing element of a DP computing system can comprise any form of hardware processor, or combination of hardware processor, memories, interconnection, and/or ancillary circuits (e.g., clocks, control, interface, and/or status circuits), that can perform operations of DP applications. DP processing elements can comprise, for example, central processing units (CPUs); accelerator-class processors; matrix processing units (MPUs), intelligence processing units (IPUs), graphics processing units (GPUs); and/or, field programmable gate arrays (FPGAs) configured to perform particular DP application computations.

DP applications, such as machine learning and neural networks, commonly involve processing tensor data, such as tensors representing elements of image data, audio data, video data, and/or natural language data. To process such data the applications perform matrix computations using matrices of tensor data. Such computations can include, for example, matrix multiplication, matrix summation, matrix convolutions, and matrix transposition.

As used herein, in reference to matrices a capital letter, such as A, is used to refer to a matrix A as a whole, while lowercase letters, such as “a”, are used to refer to an element, or set of elements, of a matrix A. The term “element”, in reference herein to a matrix, refers to the contents (e.g., a scalar value) of a row and column cell of the matrix. The notation “M×K” refers to a matrix having M number of rows and K number of columns and, “K×N” similarly refers to a matrix having K number of rows and N number of column.

In particular, machine learning and neural network applications commonly perform matrix multiplication computations, commonly referred to as “General Matrix Multiply”, or “GeMM”. A GeMM computation produces a sum of products (a “dot product”) of all elements of a row of one matrix multiplied by all elements of a column of another, where the two matrices share a dimension. For example, a “left side” M×K matrix, A, can be multiplied by a “right side” K×N matrix, B, based on the shared dimension K. The result is an M×N matrix, C, in which each element of C, cᵢⱼ for each row i and column j, is a dot product that adds the products of all K elements of row i of the left side matrix A multiplied by corresponding K elements of column j of the right side matrix B. For example, c₁₁ is computed as (a₁₁b₁₁+a₁₂b₂₁+ . . . +a₁ₖbₖ₁) for row 1 of matrix A and column 1 of matrix B; c₁₂ is computed as (a₁₁b₁₂+a₁₂b₂₂+ . . . +a₁ₖbₖ₂) for row 1 of matrix A and column 2 of matrix B; and, c₁ₙ is computed as (a₁₁b₁ₙ+a₁₂b₂ₙ+ . . . +a₁ₖbₖₙ) for row 1 of matrix A and column N of matrix B.

As used herein, the term “dot product” refers to a sum of two or more products of elements of a row of a left side matrix multiplied by a column of a right side matrix, such as dot product c₁₁ of row 1 of left side matrix A multiplied by column 1 of right side matrix B in the foregoing example The term “dot product computation”, as used herein, refers to a computing a dot product of a row of a left side matrix multiplied by a column of a right side matrix in a matrix multiplication computation.

As also used herein, the term “partial dot product” refers to a sum of one or more products of some, but not all, elements of a row of a left side matrix multiplied by a column of a right side matrix. For example, a partial dot product can comprise a product of one element of a row of a left side matrix A, and a corresponding element of a column of a right side matrix B, prior to computing and adding other products of that row of matrix A and column of matrix B, such as partial dot product (a₁₁b₁ₙ), of c₁ₙ=(a₁₁b₁ₙ+a₁₂b₂ₙ+ . . . +a₁ₖbₖₙ). In another example, dot product c=(a₁₁b₁ₙ+a₁₂b₂ₙ) is a partial dot product of c₁ₙ=(a₁₁b₁ₙ+a₁₂b₂ₙ+ . . . +a₁ₖbₖₙ) comprising a sum of the first 2 row elements of matrix A and the corresponding first 2 column elements of matrix B.

The term “complete dot product” refers herein to a sum of products of all elements, 1 to K, of a row of an M×K left side matrix multiplied by all corresponding K elements a column of a K×N right side matrix. For example, c₁ₙ=(a₁₁b₁ₙ+a₁₂b₂ₙ+ . . . +a₁ₖbₖₙ) for all values of K is a complete dot product of all K elements of row 1 of an M×K left side matrix A multiplied by all corresponding K elements column n of a K×N right side matrix B. An expression such as [Σa b)] represents herein, interchangeably, a complete dot product, and a computation of a complete dot product, of a row of a left side matrix A multiplied by a column of a right side matrix B.

DP computing systems can include processing units particularly designed, or configured, to perform matrix computations with much improved performance. As used herein, the term “matrix processing unit” (MPU) refers to any type or arrangement of processing elements (e.g., RDUs, tiles, and/or arrays of PCUs/PMUs of a tile) and/or computational circuit(s) of a DP computing system designed to perform matrix computations, and that can be configured to process large numbers of matrix elements in parallel with other MPUs, processors and/or processing elements, and/or logic circuits, to improve performance of such computations.

A “shared dimension” (SD) matrix processing system can take advantage of a shared dimension of a left side and a right side matrix to improve computational latency, communications/data transfer (e.g., among MPUs and/or resources of MPUs) latency, and/or utilization of hardware resources of a DP system. An SD processing system can include an “SD splitter” component that can divide, or “split”, an M×K left side matrix and a K×N right side matrix based on their shared dimension, K. As used herein, the term “Shared Dimension Matrix Processor” (SDMP) refers to a computing system (e.g., an RDS) configured to perform matrix multiplication based on splitting “parent” multiplicand matrices along a shared dimension of the parent matrices. An SDMP can comprise, for example, a DP computing system having an SD splitter, to split parent matrices into SD “split matrices”, and having multiple MPUs each configured to each compute a subset of products and/or dot products of the split matrices in parallel with each other.

An SD splitter can split “parent” left and right side matrices into pairs of “column-split” and “row-split” matrices, in which each pair comprises a fraction of respective columns and rows among dimension K shared by the parent matrices. For example, to multiply an M×K left side parent matrix, A, by a K×N right side parent matrix, B, an SD splitter can split parent matrix A into two M×(K/2) column-split matrices, A₀ and A₁, and can split the parent matrix B into two (K/2)×N row-split matrices, B₀ and B₁. Matrices A₀ and A₁ can each have (K/2) number of the K columns of the left side parent, and matrices B₀ and B₁ can each have (K/2) rows of the right side matrix. Column-split matrix A₀ can comprise, for example, all M rows and columns 1 to (K/2) of the left side parent, and column-split matrix A₁ can comprise all M rows and columns (K/2)+1 to K of the left side parent. Row-split matrix B₀ can comprise, correspondingly, rows 1 to (K/2) and all N columns of the right side parent, and column-split matrix A₁ can comprise rows(K/2)+1 to K and all N columns of the right side parent.

SD MPUs of the SDMP can then multiply the column- and row-split matrices along dimension (K/2) to compute two partial dot products, corresponding to their respective (K/2) portions of the parent matrices. For example, one SD MPU can compute a partial dot product comprising a sum of (K/2) products of a row of matrix A₀ multiplied by a column of matrix B₀. A second SD MPU can compute a second partial dot product comprising a sum of (K/2) products of a row of matrix A₁ multiplied by a column of matrix B₁. One of the two SD MPUs (or, alternatively, another SD MPU or an adder circuit, such as an adder arithmetic logic unit, “ALU”) can then add the two partial dot products to compute a complete dot product of the corresponding row of the left side parent matrix multiplied by the corresponding column of the right side parent matrix, which can then be an element cᵢⱼ of an M×N results matrix C.

In particular, in an SDMP the two SD MPUs can compute their respective row/column products, and/or partial dot products, in parallel, reducing overall compute latency to compute a complete dot product of any one row and columns of the left and right side matrices. Additionally, as one of the SD MPUs can add the partial dot products, using adder circuitry to compute its respective partial dot product, an SDMP can reduce the hardware components required to compute a complete dot product of any one row and columns of the left and right side matrices

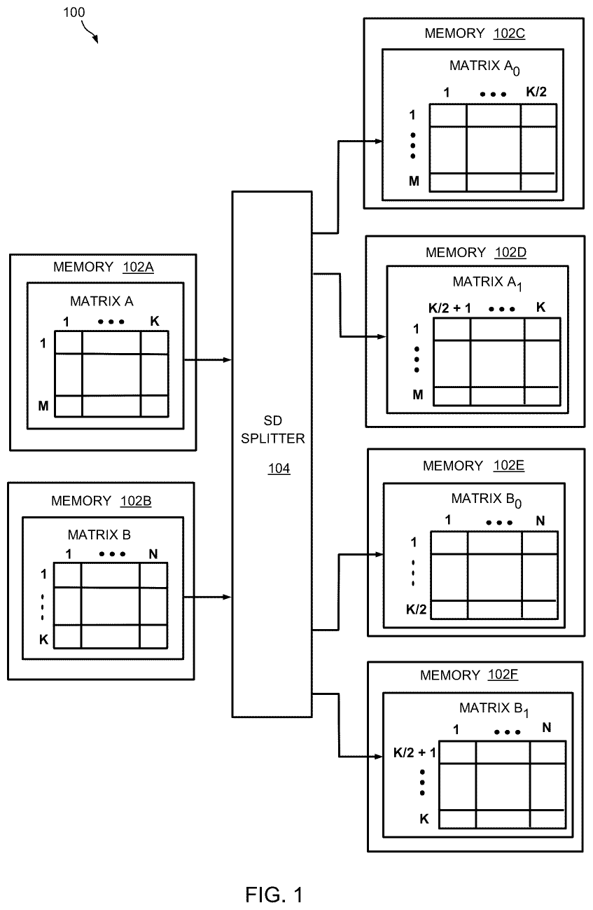

FIG. 1 illustrates an example split, or division, of two parent matrices, M×K left side matrix A and K×N right side matrix B, based on a shared dimension, K. FIG. 1 illustrates example SDMP 100 comprising memories 102A-102F (collectively, “memories “102”) and SD splitter 104. Memories 102A and 102B are shown in FIG. 1 containing, respectively, matrix A and matrix B. SD splitter 104 can split matrices A and B into respective column-split and row-split matrices. For example, SD splitter 104 can receive or access matrix A in memory 102A and can split matrix A into split matrices A₀ and A₁, shown in FIG. 1 in respective memories 102C and 102D, such that each of column-split matrices A₀ and A₁ comprise the M rows of matrix A and (K/2) number of columns. Column-split matrix A₀ is shown in FIG. 1 comprising columns 1 to (K/2), and column-split matrix A₁ is shown comprising columns (K/2)+1 to K, of left side parent matrix A.

Similarly, SD splitter 104 can receive or access right side parent matrix B in memory 102B and scan split matrix B into row-split matrices B₀ and B₁, shown in FIG. 1 in respective memories 102E and 102F, such that each of split matrices B₀ and B₁ comprise the N columns of parent matrix B and (K/2) number of rows. In FIG. 1 split matrix B₀ is shown comprising row 1 to (K/2), and split matrix B₁ comprising rows (K/2)+1 to K, of parent matrix B. MPUs of an SDMP comprising SD splitter 104 can compute, in parallel with each other, partial and/or complete dot products of each of matrix A₀ multiplied by matrix B₀, and matrix A₁ multiplied by matrix B₁.

MPUs of an SDMP (not shown in FIG. 1) can receive or can access split matrices A₀, A₁, B₀, and B₁ in respective memories 102C—102F to compute products and/or partial dot products of matrix A₀ multiplied by matrix B₀ and products, or partial dot products, of matrix A₁ multiplied by matrix B₁. One or more MPUs of the system can add the products and/or partial dot products to compute a complete dot product element, cᵢⱼ, of a matrix C result of multiplying parent matrices A and B.

In implementations, an SD splitter can comprise, or can be included in, a processor of an SDMP, such as host processor, runtime processor, RDU, and/or PCUs of tiles of an RDS and/or a program executable on one or more of these. An SD splitter can comprise a specialized logic circuit designed to split input matrices into split matrices. An SD splitter can comprise a compiler of an SDMP that can generate split matrices as, for example, an output of compiling a machine learning application model (e.g., an execution or configuration file of an RDS such as in the examples of Grohoski and Kumar). An SD splitter can comprise a configuration or runtime component of an SDMP (e.g., runtime processor of an RDS) and can generate split matrices as an output of configuring resources of an SDMP to execute or train a machine learning application model In implementations split matrices can be components of data associated with performing matrix operations in an SDMP (e.g., an RDS comprising an SDMP). For example, split matrices can be components of an execution file, an application graph, and/or configuration file of an RDS.

An SD splitter comprise an input function of an SDMP to input left and right side parent matrices A and B into the MPUs for multiplying matrix A and matrix B. For example, an SD splitter can comprise a memory read function of an SDMP to read matrices A and B from a memory. When reading matrix A from the memory to input matrix A into the MPUs, for a memory address of matrix A in the memory corresponding to an address among columns 1 to (K/2) of matrix A, the SD splitter can output elements of these columns of matrix A from the memory to one set of MPUs (and/or to an M×(K/2) column-split matrix in a memory). For a memory address of matrix A corresponding to an address among columns (K/2)+1 to K of matrix A, the SD splitter can output elements of these columns of matrix A from the memory to another set of MPUs (and/or to another M×(K/2) column-split matrix in a memory).

Similarly, when reading matrix B from the memory to input matrix B into the MPUs, for a memory address of matrix B in the memory corresponding to an address among rows 1 to (K/2) of matrix B, the SD splitter can output elements of these rows of matrix B from the memory to one set of MPUs (and/or to (K/2)×N row-split matrix in a memory). For a memory address of matrix B in the memory corresponding to an address among rows (K/2)+1 to K of matrix B, the SD splitter can output elements of these rows of matrix B from the memory to another set of MPUs (and/or to another (K/2)×N row-split matrix in a memory). In some implementations (e.g., an implementation in which memories containing matrices A and/or B comprise multiple read ports) the SD splitter can concurrently read multiple columns of parent matrix A and/or rows of parent matrix B such that the SD splitter can concurrently read columns of matrix A and/or rows matrix B.

In implementations, memories among memories 102A-102F can be the same memory, or can be different memories. For example, memories 102C-102F can be memories of a host processor, runtime processor, RDU, and/or PMUs of tiles of an RDS. Memories 102C-102F can include memories communicatively coupled to an SDMP, and/or to an SD splitter.

As used herein, “SD MPUs” refers to MPUs of an SDMP designed or configured to compute dot products of split matrices, such as A₀ and B₀ and/or A₁ and B₁ in the examples of FIG. 1. Computing dot products in multiplying two matrices can be performed as “multiply-accumulate (MACC)” computations. In such computations an adder can add individual matrix products (e.g., a₁₁ times b₁₁ in matrices A and B). As an MPU computes products it can add the products to an accumulated value, such as in an accumulator.

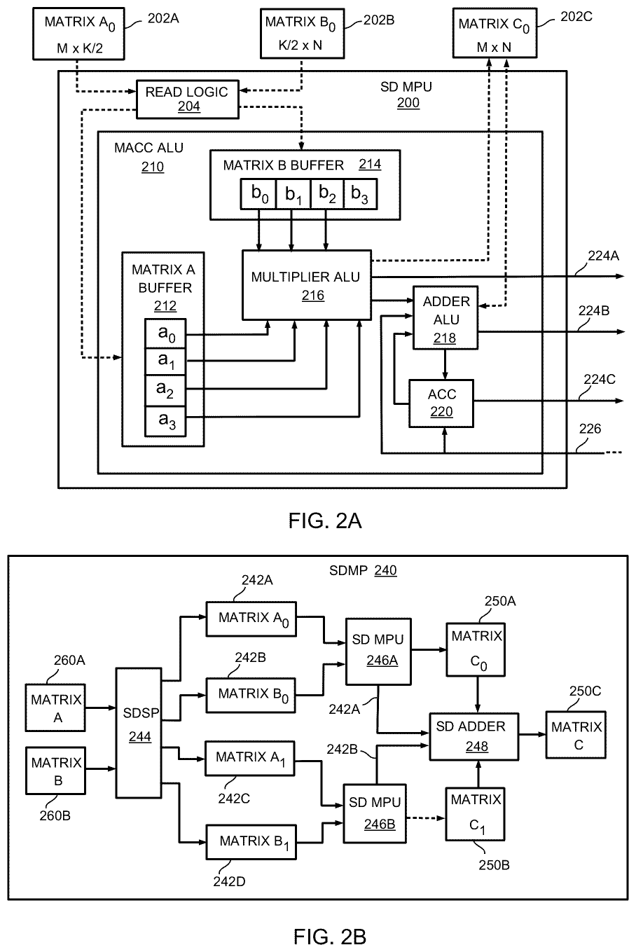

FIG. 2A illustrates an example SD MPU that can multiply split matrices in combination with other SD MPUs. SD MPU 200 is shown in FIG. 2A comprising read logic 204 and MACC ALU 210. As will be seen from further discussion of the example of MACC ALU 210, in implementations a MACC ALU can comprise multiplier logic and/or software, adder logic and/or software, and/or an accumulator. While not shown explicitly in FIG. 2A, a MACC ALU can comprise, and/or can utilize, processors such as tiles, PCUs and/or PMUs of a tile, and/or other types of processors, to multiply matrix elements and/or add matrix products in computing dot products.

FIG. 2A further illustrates matrix 202A comprising M×(K/2) matrix A₀, matrix 202B (K/2)×N matrix B₀, matrix 202C comprising M×N matrix C₀, and MACC ALU 210. Matrices 202A, 202B, and/or 202C, or elements of the matrices, can be included in memories of an SDMP (e.g., memories of SD MPU 200 or of another MPU, not shown explicitly in FIG. 2A), such as memories of MPUs that can include instance of a MACC ALU such as MACC ALU 210. Elements of the matrices can be included in hardware registers of components of an SDMP, such as registers of RPs (e.g., registers of SD MPU 200 or of another MPU, not shown explicitly in FIG. 2A).

In FIG. 2A dashed lines indicate transfers of data, such as elements of matrices 202A, 202B, and 202C, and/or products or dot products computed by MACC ALU 210, among storage elements containing the data. Read logic 204 can operate to transfer (e.g., read from a memory or hardware registers) elements of matrices 202A and 202B for input to MACC ALU 210. While not shown in FIG. 2A, one of ordinary skill in the art will appreciate that implementations can comprise any of a variety of hardware mechanisms to achieve such transfers, according to the type and/or location of the storage elements (e.g., type and/or location of memories) storing the data. For example, such transfers can be achieved using I/O buses, I/O links, and/or I/O interface hardware; processor nests and/or interconnect fabrics; and//or, even I/O or communications networks. Solid lines with arrows in FIG. 2A indicate hardware interconnections and/or interconnection interfaces, communicatively and/or operatively coupling components of MACC ALU 210 and/or other hardware components of an SDMP (e.g., other MPUs and/or memories of an SDMP).

Matrix 202A can comprise an M×(K/2) column-split matrix of an M×K left side parent matrix A, and matrix 202B can comprise a (K/2)×N row-split matrix of a right side parent matrix B, where matrix A and B are split on shared dimension K, such as illustrated in the example of FIG. 1. Matrix 202C can comprise an M×N split matrix dot product results of multiplying matrix 202A and matrix 202B. More particularly, matrix 202C can comprise (K/2) number of dot products of elements 1 to (K/2) of rows 1 to M of matrix 202A multiplied by corresponding (elements of columns 1 to (K/2) of columns 1 to N of matrix 202B.

To compute dot products of elements of a row of matrix 202A multiplied by elements of a column of matrix 202B, SD MPU 200, and/or MACC ALU 210, can execute from 2 to (K/2) number of MACC computation cycles to input elements (e.g., via read logic 204) of matrices 202A and 202B to MACC ALU, multiply the elements, and sum the products. FIG. 2A illustrates MACC ALU 210 comprising matrix A buffer 212, matrix B buffer 214, multiplier arithmetic login unit (ALU) 216, adder ALU 218, and SD accumulator ACC 220. To compute elements of matrix 202C, in each MACC cycle read logic 204 can input to MACC ALU 210 a set of elements (4 elements in the example of FIG. 2A) of matrix 202A into elements a₀, a₁, a₂, and a₃ of matrix A buffer 212. Also in each MACC cycle MACC ALU 210 can input a set of elements (4 elements in the example of FIG. 2A) of matrix 202B into elements b₀, b₁, b₂, and b₃ of matrix B buffer 214.

In MACC computation cycles multiplier ALU 216 can multiply a pair of buffer A and corresponding buffer B elements and output the products to adder ALU 218. Adder ALU 218 can add the products to a value of ACC 220 to a partial dot product summing products of other elements of matrix 202A and 202B, compute a complete dot product for a particular row of matrix 202A and column of matrix 202B. For example, multiplier ALU 216 can compute each product (a₀b₀), (a₂b₂), and (a₃b₃) and can output each of the products to adder ALU 218. Adder ALU 218 can add each product to ACC 220 to compute a partial dot product of a row of matrix 202A and column of matrix 202B.

As previously described, a partial dot product can comprise a single product of one element of a row of a left side matrix and a corresponding element of a column of a right side matrix. ACC 220 can comprise dot products computed for products of a row of matrix 202A and column of matrix 202B. MACC ALU 210 can, optionally, output the value of ACC 220 as a partial or complete dot product (comprising all (K/2) products) of a row of matrix 202A multiplied by a column of matrix 202B. MACC ALU 210 can initialize ACC 220 to have the value of product (a₀b₀) corresponding to the first column element of that row of matrix 202A (in matrix A buffer 212 a₀) multiplied by the first row element of that column of matrix 202B (in matrix B buffer 214 b₀). The initial dot product, as stored in ACC 220, is then just the product (a₀b₀) prior to computing and adding to ACC 220 products (a₁b₁), (a₂b₂), and (a₃b₃).

FIG. 2A illustrates that SD MPU 200 can, optionally, output products and/or dot products of matrix 202A multiplied by matrix 20B to matrix 202C (e.g., to a memory, or set of registers, containing elements of matrix 202C). For example, multiplier ALU 216 can, optionally, output products, and/or adder ALU 218 can, optionally, output dot products to matrix 202C. Adder ALU 218 can, optionally, then input products/dot products from matrix 202C to add to values in ACC 220 and or to products input to adder ALU 218 from multiplier ALU 216. Matrix 202C can additionally, or alternatively, comprise products and/or dot products computed by another MPU or MACC ALU, such as another MPU similar to SD MPU 200 or another MACC ALU similar to MACC ALU 210.

Matrix 202C can, then, comprise partial results of multiplying parent matrices A and B (not shown in FIG. 2A), such as results for rows 1 to (K/2) of parent matrix A multiplied by columns 1 to (K/2) of parent matrix B. Multiple such SD MPUs can output products and/or dot products of split matrices to memories, and other SD MPUs can input the products/dot products from the memories to compute additional dot products of two parent matrices A and B. For example, another SD MPU can access products, and/or dot products, in matrix 202C to compute dot products of elements of matrix C₀ added to products/dot products computed, by SD MPU 200 or another SD MPU, for rows (K/2)+1 to K of matrix A (e.g., included in a column-split matrix A₁) multiplied by columns (K/2)+1 to K of matrix B (included in a row-split matrix B₁.

FIG. 2A further illustrates that MACC ALU 210 can, optionally, output products, and/or dot products, of matrix 202A (A₀) multiplied by matrix 202B (B₀) to outputs 224A, 224B, and/or 224C (collectively, “outputs 224”). MACC ALU 210 can input to adder ALU 218 and/or ACC 220, via input 226, products/dot products computed, for example, by another SD MPU similar or equivalent to SD MPU 200. The products/dot products input via input 226 can be output from another SD MPU having outputs similar or equivalent to outputs among outputs 224. MACC ALU 210 can add products and/or dot products received via input 226 to ACC 220 to compute partial and/or complete dot products of elements of matrix C₀ as a sum of products/dot products computed for rows (K/2)+1 to K of matrix A (e.g., included in a column-split matrix A₁) multiplied by columns (K/2)+1 to K of matrix B (included in a row-split matrix B₁) by one or more other SD MPUs. Thus, multiple SD MPUs, such as SD MPU 200, can work in parallel and/or in pipeline configurations, using split matrices, to compute dot products of left side and right side parent matrices.

While not shown in FIG. 2A, in implementations SD MPU 200 can comprise, and/or can be included in, an RDU, tiles of a RDU, and/or PCUs and/or PMUs of a tile, of an RDS, such as illustrated in the examples of Grohoski and Kumar. SD MPU 200 can be communicatively coupled to a processor, other SD MPUs, and/or other components of an SDMP. It will be appreciated by one of ordinary skill in the art that an SD MPU, such as the example of SD MPU 200, can comprise, be incorporated into, any of a variety of DP computing systems and/or software and/or hardware components of DP computing systems.

As just described, in implementation a plurality of SD MPUs can each multiply a set of split matrices generated from a pair of parent matrices, which can enable an SDMP to multiply two parent matrices in parallel among the SD MPUs. In FIG. 2B example SDMP 240 illustrates an SD matrix processor comprising multiple SD MPUs to perform a matrix multiply of two parent matrices based on a shared dimension of the two matrices. As in the example of FIG. 2A, in FIG. 2B dashed lines indicate transfers of data, such as elements of matrices and/or products/dot products computed by SD MPUs of SDMP 240, among storage elements (e.g., registers and/or memories) of or coupled to SDMP 240 containing the data.

While not shown in FIG. 2B, it will be appreciated by one of ordinary skill in the art that SDMP 240, and/or components of SDMP 240, can employ any of a variety of hardware mechanisms to achieve such transfers, according to the type and/or location of the storage elements (e.g., type and/or location of registers/memories) storing the data. For example, such transfers can be achieved using I/O buses, I/O links, and/or I/O interface hardware; processor nests and/or interconnect fabrics; and//or, even I/O or communications networks. Also similar to the example of FIG. 2A, solid lines with arrows in FIG. 2B indicate hardware interconnections and/or interconnection interfaces, communicatively and/or operatively coupling components of SDMP 240.

In FIG. 2B, SDMP 240 is shown comprising matrix 260A and matrix 260B (collectively, “matrices 260”); matrix 242A, matrix 242B, matrix 242C, and matrix 242D (collectively, “matrices 242”); and, matrix 250A, matrix 250B, and matrix 250C (collectively, “matrices 250”). Matrix 260A can be an M×K left side matrix, matrix 260B can be a K×N right side matrix, and matrix 250C can be an M×N matrix of dot products of multiplying matrix 260A by matrix 260B.

Matrices 242 can be SD split matrices generated based on shared dimension K of matrices 260 such as in the examples of FIG. 1B. Matrix 242A can be an M×(K/2) column-split matrix comprising rows 1 to M and columns 1 to (K/2) of matrix 260A, and matrix 242C can be an M×(K/2) column-split matrix comprising rows 1 to M and columns (K/2)+1 to K of matrix 260A. Similarly, matrix 242B can be an M×(K/2) row-split matrix comprising rows 1 to (K/2), and column 1 to N, of matrix 260B and matrix 242D can be an M×(K/2) row-split matrix comprising rows (K/2)+1 to K, and columns 1 to N, of matrix 260B.

Matrix 250A can be a results matrix comprising products, partial dot products, and/or complete dot products of multiplying matrix 242A and matrix 242B. Matrix 250A can be a results matrix comprising products, partial dot products, and/or complete dot products of column elements 1 to K/2 of a row of matrix 242A multiplied by corresponding row elements 1 to K/2 of a column of matrix 242B. Matrix 250B can be a similar M×N matrix comprising products, partial dot products, and/or complete dot products of column elements 1 to K/2 of a row of matrix 242C multiplied by corresponding row elements 1 to K/2 of a column of matrix 242D. Matrix 250C can be a results matrix comprising sums of product and/or dot product elements included in matrix 250A and/or matrix 250B.

While not shown explicitly in FIG. 2B, matrices among matrices 260, matrices 242, and/or matrices 250 can be included in storage elements of SDMP 240, such as registers/register sets and/or memories of (or, memories accessible to components of) SDMP 240. SDMP 240 can comprise an RDS, for example, and the storage elements can be included in a node, RDU, tile, and/or PCUs/PMUs of a tile, of the RDS. Storage elements containing matrices among matrices 260, matrices 242, and/or matrices 250 can be the same memories. such as in the case that the same SD MPU, or components of the same SD MPU, process elements of differing matrices among matrices 260, matrices 242, and/or matrices 250, or that differing SD MPUs can advantageously (e.g., based on performance) process the matrices in the same storage elements. Additionally, or alternatively, the storage elements can be different storage elements, such as in the case that certain SD MPUs process one matrix, and other SD PUs process other matrices, and the particular storage elements are advantageous for particular SD MPUs to process them.

FIG. 2B further depicts SDMP 240 comprising SDSP 244; SD MPU 246A and 246B (collectively, “SD MPUs 246”); and, SD adder 248. SDSP 244 can comprise an SD splitter component of SDMP 240, such as previously described in reference to FIG. 1, and can split parent matrices along a shared dimension, such as dimension K. SDSP 244 can receive (or, otherwise access) matrix 202A and/or matrix 202B and can form split matrices 242A (A₀) and 242C (A₁) from matrix 260A, and split matrices 242B (B₀) and 242D (B₁) from matrix 260B.

In implementations, SD MPUs 246 can be SD MPUs similar or equivalent, for example, to SD MPU 200 of FIG. 2A. As can be seen in FIG. 2B, SD MPU 246A can multiply split matrices 242A and 242B to compute products and/or dot products of matrices 242A and 242B, and can store the products/dot products in matrix 250A. SD MPU 246B can multiply split matrices 242C and 242D to compute products and/or dot products of matrices 242C and 242D, and can store the products/dot products in matrix 250B. SD adder 248 can add products, and/or dot products, in each of matrix 250A and matrix 250B to compute dot product elements of matrix 250C.

For example, SD MPU 246A can output to matrix 250A one or more products and/or dot products of matrix 242A multiplied by matrix 242B. SD MPU 246B can output to matrix 250A one or more products and/or dot products of matrix 242C multiplied by matrix 242D. Alternatively, or additionally, SD MPU 246A can output to SD adder 248 one or more products and/or dot products of matrix 242A multiplied by matrix 242B. Similarly, alternatively or additionally, SD MPU 246B can output to SD adder 248 one or more products and/or dot products of matrix 242C multiplied by matrix 242D. SD adder 248 can receive products/dot products output to matrix 250A, and/or from SD MPU 246A, and products/dot products output to matrix 250B, and/or from SD MPU 246B, and can add the products/dot products to compute dot product elements of matrix 250C.

In implementations, SD adder 248 can comprise an adder ALU and, optionally, accumulator, such as adder ALU 218 and ACC 220 in FIG. 2A. SD adder 248 can be an adder included in one of SD MPUs 246, another SD MPU of SDMP 240 (not shown explicitly in FIG. 2B), or an adder component of SDMP 240 not necessarily included in an SD MPU of SDMP 240 (e.g., a “stand alone” adder component comprising an adder ALU and, optionally, an accumulator).

In FIG. 2B, SD MPUs 246 can compute, and/or output, one or more products, and/or dot products, of matrix 242A multiplied by matrix 242B, and/or one or more products, and/or dot products, of matrix 242C multiplied by matrix 242D, in any particular combination and/or sequence. For example, SD MPU 246A can, in any particular combination and/or sequence, compute products and/or dot products of matrix 242A multiplied by matrix 242B and can, in any particular combination and/or sequence, output these results to matrix 250A and/or SD adder 248. Similarly, SD MPU 246B can, in any particular combination and/or sequence, compute products and/or dot products of matrix 242C multiplied by matrix 242D and can, in any particular combination and/or sequence, output these results to matrix 250C and/or SD adder 248. SD adder 248 can receive product/dot product outputs from matrix 250A, matrix 250B, SD MPU 246A, and/or SD MPU 246B in any particular combination and/or sequence, and can add these in any combination and/or sequence to compute dot product results of matrix 260A multiplied by matrix 260B to output to matrix 250C.

The examples of FIGS. 1A and 2B use the example of splitting two parent (multiplicand) matrices, along shared dimension K, into two pairs of split matrices, each comprising (K/2) number of rows and corresponding (K/2) number of columns. However, this is only to illustrate the examples and not intended to limit implementations. One of ordinary skill in the art will appreciate that, within the scope and spirit of the example of FIGS. 1A and 2B, an SD splitter can generate, along a shared dimension, K, an arbitrary number of pairs of split matrices adding to K total number of rows/columns among the pairs of split matrices. For example, in FIG. 2A matrix 202A can comprise (K/n) rows and matrix 202B can comprise (K/n) columns, where “n” is any value less than K. Similarly, one of ordinary skill in the art will appreciate that an SD splitter can generate, within the scope and spirit of the example of FIGS. 2A and 2B, multiple pairs of split matrices, each comprising a respective number of rows/columns differing from those of other pairs, so long as the totality of rows/columns among the pairs does not exceed K.

Additionally, in implementations pairs of split matrices need not comprise the same number of column/row portions (e.g., K/n for n number of split matrices). For example, shared dimension K of two parent matrices (M×K and K×N) can be odd, such that splitting the parent matrices into two pairs of column- and row-split matrices leaves one pair with a (K/2) portion and the other with (K/2)−1 portion.

However, it can be advantageous to generate symmetric pairs of matrices, such that each column-split matrix and each row-split matrix among pairs of column- and row-split matrices all have the same row and column dimensions. This can facilitate computing partial dot products of the pairs of split matrices in parallel in a uniform number of compute cycles to compute products and sum of products of each of the pairs of matrices. For example, if K=10, an SD splitter can split the parent matrices into 3 pairs of split matrices having dimensions M×3 and 3×N— such as A₀/B₀, A₁/B₁, and A₂B₂—and 1 pair of split matrices, A₃/B₃, having dimensions M×1 and 1×N.

As matrices A₃ and B₃ are asymmetric with respect to matrices A₀/B₀, A₁/B₁, and A₂B₂, SD MPUs computing a partial dot product of A₃ and B₃ can compute the partial dot product in one dot product computation cycle, while SD MPUs computing partial dot products of matrices A₀/B₀, A₁/B₁, and A₂B₂ compute their respective partial dot products in three dot product computation cycles. Alternatively, an SD splitter can generate matrices A₃ and B₃ to include respective columns and rows of all zeros, such that matrices A₃ and B₃ are generated as respective M×3 and 3×N matrices and are symmetric to matrices A₀/B₀, A₁/B₁, and A₂B₂. The SD MPUs can then compute their respective partial dot products in parallel in the same 3 dot product computation cycles, without having to synchronize computation of a partial dot product computed in a single dot product computation cycle with computation of partial dot products computed in an asymmetric (e.g., 3) number of dot product computation cycles.

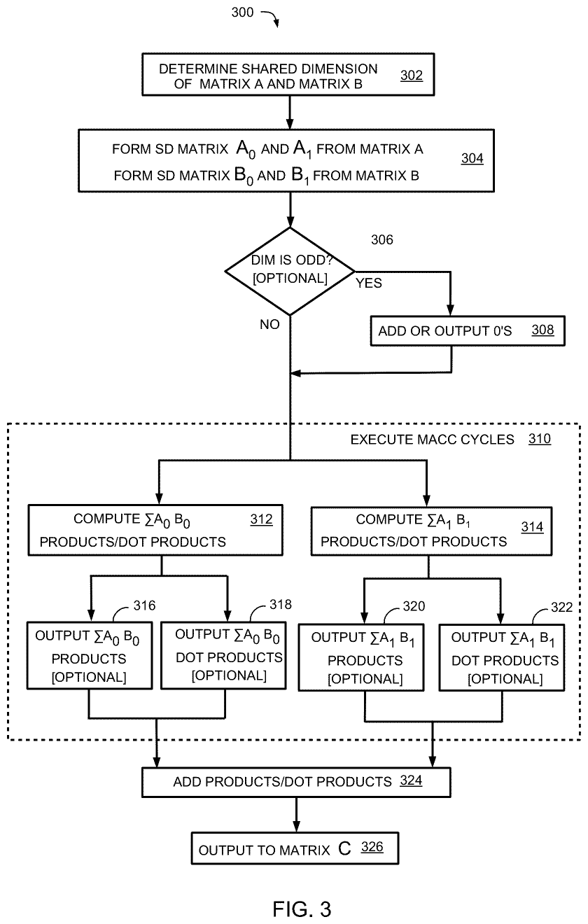

FIG. 3 illustrates example method 300 for performing matrix multiplication using split matrices, such as in the examples of FIGS. 1-2B. For purposes of illustrating the example, but not intended to limit implementations, the method is described as performed by an SDMP, such as SD MPU 200 in FIG. 2B, comprising an SD splitter component or function, such as SD splitter 104 in FIG. 1 or SDSP 244 in FIG. 2B, and SD MPUs such as illustrated by SD MPUs 246 in FIG. 2B. Also for purposes of illustrating the method, but not intended to limit implementations, method 300 continues the example of two matrices, M×K left side matrix A and K×N right side matrix B, split into respective two pairs of column- and row-split matrices based on shared dimension K of matrices A and B.

In operation 302 the SD splitter determines that matrix A and matrix B share dimension K. Based on matrix A and B sharing dimension K, in operation 304 the SD splitter divides matrix A into column-split matrices A₀ and A₁ and the divides matrix B into row-split matrices B₀ and B₁. In operation 304, the SDMP SD splitter can form the split matrices as previously described in reference to FIGS. 1-2B.

In operation 306, the SD splitter can, optionally, determine if dimension K is odd. If so, splitting matrix A and B into two pairs of SD matrices can result in one of SD matrix A₀ and A₁ having dimension M×(K/2) and the other of matrix A₀ and A₁ having dimension M×(K/2+1), and one of SD matrix B₀ and B₁ having dimension (K/2)×N and the other of matrices B₀ and B₁ having dimension (K/2+1)×N. For example, if K=5, splitting matrices A and B into two pairs of SD matrices results in, for example, matrix A₀ having dimension M×3 and the and matrix A₁ having dimension M×2. Similarly, splitting matrices A and B on dimension K=5 results in matrix B₀, for example, having dimension 3×N and matrix B₁ having dimension 2×N.

Based on determining, in operation 306, that K is odd, in operation 308 the SD splitter can add an extra column (e.g., column 3 of M×2 matrix A₁ in the foregoing example) of all zeros, and can add an extra row (e.g., row 3 of 2×N matrix B₁ in the foregoing example) of all zeros. SD MPU 246B can, concurrently, each execute 3 MACC computations to compute, respectively, a complete dot product of a row of M×3 matrix A₀ multiplied by a column of 3×N matrix B₀, and a complete dot product of a row of M×3 matrix A₁ (as extended with all zeros in column 3) multiplied by a column of 3×N matrix B₁ (as extended with all zeros in row 3). The all-zeros column and/or row can permit the SDMP to compute dot products of each pair of matrices symmetrically (each performing the same number of concurrent MACC computation), as the SDMP multiplying last column element of a row of matrix A₁ and the last row element of a column of matrix B₁ produces all a value of zero to include in dot products of matrices A₁ and B₁.

Alternatively, based on determining, in operation 306, that the shared dimension (e.g., K) is odd, in operation 308 an SDMP can program a processor, circuit, or memory (e.g., a processor, memory, or memory read or other special circuit of MPU₀ and/or MPU₁) to output zeros as elements of the (K/2)+1 column of a row of matrix A₁ and/or (K/2)+1 elements of a row of matrix B₁. In computing in computing product (a₁₃×b₁₃), for example, the SDMP can output a value of zero for element b₁₃ and/or a value of zero for an. Value zero for elements an and/or b₁₃ produces a zero-value product to include in dot products of matrices A₁ and B₁, such that SD MPU 246A and SD MPU 246B can concurrently execute a symmetric number (3) of MACC computations to compute respective dot products of matrix A₀ multiplied by matrix B₀ and matrix A₁ multiplied by matrix B₁.

In operation 310, the two sets of SD MPUs, MPU₀ and MPU₁, performs MACC cycles to compute dot products of a row of matrix A₀ multiplied by a column matrix B₀ and dot products of a row of matrix A₁ multiplied by a column matrix B₁. In implementations, MPU₀ and MPU₁ can each comprise one MPU, or one or both MPU₀ and MPU₁ of can comprise a plurality of MPUs operating in parallel as one combined SD MPU. To compute the dot products symmetrically (and, optionally, concurrently), MPU₀ and MPU₁ each perform K/2 (K/2 plus 1 if K is odd) number of MACC cycles.

In operation 312 of the (K/2) MACC cycles MPU₀ computes products and/or dot products of a row of matrix A₀ multiplied by a column of matrix B₀, and in operation 314 MPUs computes products and/or dot products of a row of A₁ multiplied by a column of matrix B₁. In operation 316 of the (K/2) MACC cycles MPU₀ can, optionally, output products computed in operation 312. In operation 318, MPU₀ can, optionally, output dot products computed in operation 312, and the dot products output by MPU₀ can be partial dot products and/or can be complete dot products. Similarly, in operation 320 of the (K/2) MACC cycles MPU₁ can, optionally, output products computed in operation 314 and/or, in operation 322 MPU₁ can, optionally, output dot products computed in operation 314. In operation 322 dot products output by MPU₁ can be partial dot products and/or can be complete dot products.

To compute products/dot products in operations 312 and 314, as described in reference to operation 308, for odd values of K the SD splitter can add a column of zeros to the smaller of split matrices A₀ and A₁, and can add a row of zeros to the smaller of split matrices B₀ and B₁. Alternatively, as also described in reference to operation 308, to compute products/dot products in operations 312 and 314 MPU₀ and MPU₁ (or, a read circuit reading matrices A₀, A₁, B₀, and B₁ from a memory, for example) can output zeros for the (K/2)+1 elements of the smaller of split matrices A₀ and A₁, and the smaller of split matrices B₀ and B₁.

In operations 316, 318, 320, and/or 322 MPU₀ and/or MPU₁ can output products/dot products to an adder component of the SDMP. In implementations, an adder component of the SDMP can comprise, for example, an adder ALU such as adder ALU 218 in FIG. 2A. The adder ALU can be included in a MACC ALU of an MPU, such as a MACC ALU of MPUs or another MPU of the SDMP, or the adder ALU can be an adder ALU of the SDMP that need not necessarily be a component of an MPU, or of a MACC ALU.

In operation 324, the adder can add products/dot products output by MPU₀ and MPU₁ to compute a complete dot product corresponding to a dot product of a row of parent matrix A multiplied by a corresponding column of parent matrix B. In implementations MPU₀ and/or MPU₁ can output, in operations 316, 318, 320, and/or 322 products/dot products to memories and/or registers, and the adder can access the products and/or dot products of in the memories/registers. Alternatively, in operations 316, 318, 320, and/or 322 MPU₀ and/or MPU₁ can output the products and/or dot products directly to the adder. In operations 316, 318, 320, and/or 322 MPU₀ and MPU₁ can output any combination of products and/or dot products and in any particular order or sequence. In operation 324 the adder can receive and/or add outputs of MPU₀ and MPU₁ in any combination or sequence to produce a complete dot product.

In operation 326, the adder outputs the complete dot product. In operation 326 the adder can output the complete dot product of a row and column of respective matrices A and B to other MPUs, such as a successive forward and/or backward layer in a neural network. Additionally, or alternatively, in operation 326 the adder can output the complete dot product of a row and column of respective matrices A and B to a memory or registers, such as a memory containing a complete matrix C to receive the results of matrix A multiplied by matrix B.

In implementations, SDMPs, and/or components of SDMPs (e.g., SD MPUs), such as in the examples of FIGS. 2A and 2B, can perform operations of method 300 to compute ΣAB utilizing split matrices, and can perform such operations as described in reference to the examples of FIGS. 2A and 2B. The example of method 300 is intended to illustrate the disclosure but not to limit implementations. It would be appreciated by one of ordinary skill in the art, for example, that an SD splitter need not be limited to splitting two parent matrices into only 2 pairs of split matrices. An SD splitter can, alternatively, split two parent matrices into “n” number pairs of split matrices having shared dimension (K/n). One of ordinary skill in the art will understand that K need not be an even multiple of n, and would understand to modify method 300 to add rows/columns of zeros to smaller split matrices to product n number of split matrices all having the same number of rows/columns among shared dimension K, and/or to output zeros when multiplying elements of larger split matrices by elements of rows/columns not included in smaller split matrices.

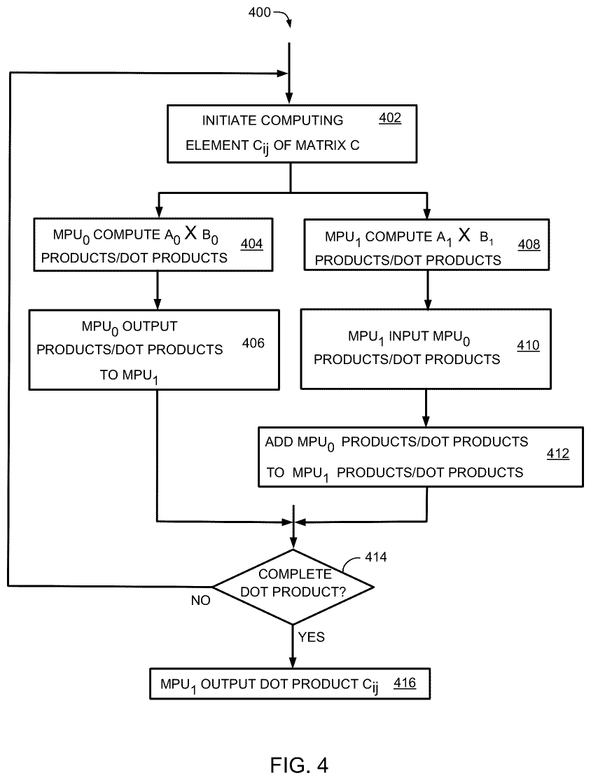

As has been described in reference to operations 316, 318, 320, and 322, for example, SD MPUs can compute products and/or dot products for one split matrix (e.g., a row of one split matrix multiplied by a column of another split matrix) and can output the products/dot products to another SD MPU. The receiving SD MPU can add the products/dot products to product/dot products computed by that and/or other SD MPUs. FIG. 4 illustrates an example method for multiple SD MPUs to compute products/dot product of different split matrices, to output the products/dot products to another SD MPU, and for the receiving SD MPU to add the output products/dot products to compute a combined dot products.

Similar to FIG. 3, method 400 of FIG. $ is described as performed by two SD MPUs—MPU0 and MPU1—computing products and/or dot products of two pairs of split matrices, respective M×(K/2) split matrices A₀ and A₁ and (K/2)×N split matrices B₀ and B₁. In operations 402 and 404, the SDMP can form the split matrices, for example, as previously described in reference to FIGS. 1-3.

For purpose of illustrating the method, but not intended to limit implementations, K is assumed to be even. However, as illustrated in the example of method 300 in FIG. 3, it would be appreciated by one of ordinary skill in the art that, with respect to method 400, K can be odd, where the SD splitter forms 2 split matrices. One of ordinary skill in the art will also appreciate that, as in method 300 in FIG. 3, in method 400 an SD splitter need not be limited to splitting two parent matrices into only 2 pairs of split matrices and can, alternatively, split two parent matrices into “n” number pairs of split matrices having shared dimension (K/n), and that K need not be an even multiple of n. It will be understood by one of ordinary skill in the art, in such cases, to modify method 400 to add rows/columns of zeros to smaller split matrices to product n number of split matrices all having the same number of rows/columns among shared dimension K, and/or to output zeros when multiplying elements of larger split matrices by elements of rows/columns not included in smaller split matrices.

Turning now to the details of method 400, based on two parent matrices having shared dimension K, in operation 402 the SDMP initiates computation of left side matrix A multiplied by right side matrix B (ΣAB) utilizing split column-matrices A₀ and A₁, and row-split matrices B₀ and B₁. More particularly, in operation 402 the SDMP initiates MPU₀ computing ΣA₀B₀ and MPU₁ computing ΣA₁B₁. Thus, in operation 404 MPU₀ computes products and/or dot products of ΣA₀B₀ and, in operation 408 MPUs computes products and/or dot products of ΣA₁B₁. In particular, in operation 404, MPU₀ computes products/dot products of c₁₁ among (a₁₁b₁₁+a₁₂b₂₁+ . . . +a_{1(k/2)}b_{(k/2)1}) and, in operation 408 MPU) computes products/dot products of c₁₁ among (a_{1(k/2+1)}b_{(k/2+1)1}+a₁₁b₁₁+a₁₂b₂₁+ . . . +a₁ₖbₖ)).

In operation 406 MPU₀ outputs products and/or dot products of ΣA₀B₀ to MPU). For example, in operation 406 MPU₀ can output products/dot products of a multiplier ALU, and/or an accumulator of MPU₀, to MPUs. MPU₀ can comprise a MACC ALU similar or equivalent to MACC ALU 210 in FIG. 2B, for example. The multiplier ALU and/or accumulator can be similar or equivalent to multiplier ALU 216 and accumulator ACC 220 in FIG. 2B. In operation 406 MPU₀ can output products/dot products to a memory, and/or a set of registers. Such a memory and/or registers can be memories/registers of MPU₀ and/or MPUs, such as memories/registers of an RDU comprising MPU₀ and/or MPU).

In operation 410, MPUs receives the products and/or dot products output from MPU₀. In operation 410 MPU) can receive the outputs of MPU₀ as, for example, inputs to an input such as input 226 of MACC ALU 210 in FIG. 2B. Such an input can be coupled to outputs of MPU₀ such as outputs 224 in FIG. 2B. In operation 410 MPUs can receive the outputs of MPU₀ from a memory, and/or a set of registers, containing products/dot products output by MPU0 in operation 406.

In operation 412 MPU₁ adds the products and/or dot products received from MPU₀ to products/dot products computed by MPU₁. MPU₁ can comprise a MACC ALU similar or equivalent to MACC ALU 210 of FIG. 2B, and can add products and/or dot products received from MPU₀ to, for example, an accumulator similar or equivalent to ACC 220 of FIG. 2B. The accumulator can comprise a sum of products computed by MPU₁.

In operations 406-412, to compute products/dot products of the split matrices, MPU₀ and/or MPU₁ can perform computations similar or equivalent to computations (e.g., MACC computations) of the example of SD MPU 200 in FIG. 2. In implementations, MPU₀ can output products/dot products in any particular combination and/or order, and MPU₁ can receive products/dot products output by MPU₀ in any particular combination and/or order. In operation 412, MPU₁ adds the products/dot products received from MPU₀ to products/dot products computed by MPU₁ included in an SD accumulator.

In operation 414, MPU₁ determines if the dot product computed in operation 412 is a complete dot product of all elements of a row of matrix A₀ multiplied by all corresponding elements of a column of matrix B₀, and all elements of a corresponding row of matrix A₁ multiplied by all elements of a corresponding column of matrix B₁. That is, in operation 414 MPU₁ determines if the dot product computed in operation 412 comprises a complete dot product c₁₁=(a₁₁b₁₁+a₁₂b₂₁+ . . . +a₁ₖbₖ)).

If MPU₁ determines, in operation 414, that the dot product computed in operation 412 is not a complete dot product, MPU₀ and/or MPU₁ repeat operations 404-412 to compute products/dot products needed to compute the complete dot product. If, on the other hand, MPU₁ determines in operation 414 that the dot product computed in operation 412 is a complete dot product, element cᵢⱼ of matrix C, in operation 416 MPU₁ outputs the complete dot product to matrix C.

In implementations, in operation 416 MPU₁ can output the complete dot product to a memory and/or to additional MPUs of the SDMP, such as successor forward and/or backward layer MPUs of a neural network. The SDMP can repeat operations 402 to 416 until MPU0 and MPU1 have computed a M times N number of elements of M×N matric C (e.g., all elements from c₁₁ to cₘₙ of matrix C).

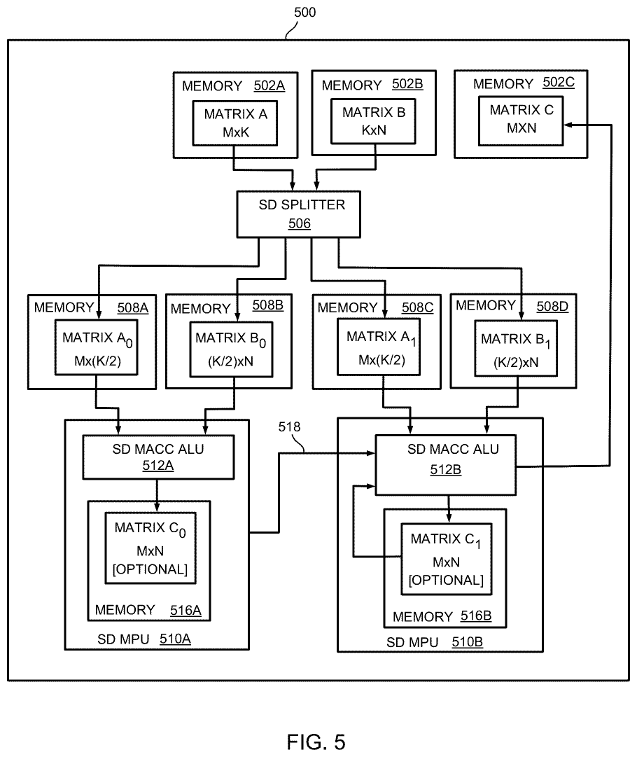

FIG. 5 illustrates an example SDMP having SD MPUs configured to compute products/dot products of split matrices in parallel, with one SD MPU outputting products/dot products to another SD MPU to add to products/dot products computed and/or received by that other SD MPU. In FIG. 5, example SDMP 500 is shown comprising memories 502A, 502B, and 502C (collectively, “memories 502”), memories 508A—508D (collectively, “memories 508”), and memories 516A and 516B (collectively, “memories 516”). In implementations, memories among memories 502, 508, and/or 516 can be memories of SDMP 500, and/or can be memories coupled to SDMP 240. Memories among memories 502, 508, and/or 516 can be memories of components of an SDMP, such as memories of a node, RDU, or a tile (e.g., memories of PCUs and/or PMUs). Memories among memories 502, 508, and/or 516 can comprise scratchpad memories and/or hardware registers (e.g., registers of an SD MPU), for example.

SDMP 500 is shown in FIG. 5 further comprising SD splitter 506. In implementations, SD splitter 506 can be similar or equivalent to SD splitter 104 of FIG. 1, and can split left side and/or right side parent matrices along a shared dimension, such as in the example of FIG. 1. FIG. 5 depicts M×K left side parent matrix A and K×N right side parent matrix B stored in respective memories 502A and 502B. Matrices A and B share common dimension K such that SD splitter 506 can split matrices A and B based on dimension K. The resulting split matrices (collectively, “split matrices 508”) are shown in FIG. 5 to include M×(K/2) column-split matrix A₀ (hereinafter, “matrix 508A”) in memory 508A, M×(K/2) column-split matrix A₁ (hereinafter, “matrix 508C”) in memory 508C, (K/2)×N row-split matrix B₀ (hereinafter, “matrix 508B”) in memory 508B, and (K/2)×N row-split matrix B₁ (hereinafter, “matrix 508D”) in memory 508D. SD splitter 506 can, for example, access matrix A and/or matrix B in memories 502A and 502B, and can store elements of matrix 508A, matrix 508B, matrix 508C, and matrix 508D in respective memories 508A—508D.

SDMP 500 is shown in FIG. 5 also comprising SD MPU 510A and SD MPU 510B (collectively, “SD MPUs 510”). In implementations, SD MPUs 510 can perform matrix computations on M×(K/2) and (K/2)×N split matrices 508 to compute an M×N dot product matrix, shown in FIG. 5 as M×N matrix C stored in memory 502C. Matrix C, computed as dot products of split matrices 508, is equivalent to an M×N matrix computed as parent matrix A multiplied by parent matrix B. As will be seen from further discussion of FIG. 5, SDMP 500 computing matrix C as dot products of split matrices 508 can improve utilization of SDMP 500 matrix compute and/or memory resources (e.g., MPUs such as SD MPUs 510, and/or memories among memories 516) as SD MPU 510A and SD MPU 510B can add products/dot products computed by the other as part of MACC computations of their respective split matrices (e.g., as illustrated by method 300 of FIG. 3 and method 400 of FIG. 4), such that no separate adder is required to compute a complete dot product of a row of matrix A and column of matrix B.

Additionally, as will also be seen from further discussion of FIG. 5, SDMP 500 computing matrix C as dot products of split matrices 508 can reduce computational latency of computing dot products, as summation of products can be computed in the same SD MPU that computes the products. For example, as will be seen from the example of FIG. 5, no pipeline successor MPU is required to receive products computed by SD MPU 510A and/or SD MPU 510B to add the products to compute a complete dot product. SDMP 500 can further reduce computational latency of dot product computations as MPU 510A and SD MPU 510B can compute respective partial dot products in parallel.

Continuing with the example of SDMP 500, in implementations SD MPUs 510A and/or 510B can be SD MPUs similar or equivalent to SD MPU 200 of FIG. 2A. Accordingly, FIG. 5 depicts SD MPUs 510A and 510B comprising respective SD MACC ALUs 512A and 512B (collectively, “SD MACC ALUs 512”). In implementations, SD MACC ALU 512A and/or 512B can be similar or equivalent to MACC ALU 210 in FIG. 2. For example, SD MACC ALUs 512 can include an adder ALU, similar or equivalent to in FIG. 2A, for example adder ALU 218 in FIG. 2A, and/or accumulator similar or equivalent to ACC 220, for example. SD MACC ALUs 512 can have inputs and/or outputs similar or equivalent to respective input 226 and outputs 224 of SD MPU 200 or MACC ALU 210 in FIG. 2.

In implementations, SD MPU 510A and/or SD MPU 510B can compute products and/or dot products of matrix 508A multiplied by matrix 508B and matrix 508C multiplied by matrix 508D. For example, SD MPU 510A can compute products and/or dot products of matrix 508A multiplied by matrix 508C, and SD MPU 510B can compute products and/or dot products of matrix 508C multiplied by matrix 508D. SD MPU 510A and/or SD MPU 510B can access matrix 508A, matrix 508B, matrix 508C, and/or matrix 508D in memories among memories 508, for example, to compute products and dot products of matrices 508.

SD MPUs 510 can compute the product and/or dot product results using a method, or operations of a method similar to method 300 of FIG. 4 and/or method 400 of FIG. 4. SD MPUs 510 can store the partial results (products, and/or partial dot products) in one or more memories. As shown in FIG. 5, SD MPU 510A can, optionally, store products and/or dot products in (optional) matrix C₀ in memory 516A, and SD MPU 510B can, optionally, store products and/or dot products in (optional) matrix C₁ in memory 516B.

In implementations, one SD MPU can compute products/dot products of one pair of split matrices and another SD MPU can compute products/dot products of another pair of split matrices. One of the SD MPUs, another SD MPU, and/or an adder component of an SDMP, can add the products/dot products together to compute a complete dot product of a row of matrix A multiplied by a column of matrix B to store in an M×N results matrix C.

FIG. 5 illustrates SD MPU 510A coupled to SD MPU 510B via output/input 518, which can also be an input to SD MPU 510B. For example, output/input 518 can comprise one or more outputs such as outputs among outputs 224 of FIG. 2A. Output/input 518 can comprise a memory interface to facilitate access by SD MPU 510B to memory 516A. As an input to SD MPU 510B, output/input 518 can comprise an input similar to input 226 of FIG. 2A.

SD MPU 510A can input elements of matrix 508A from memory 508A, and elements of matrix 508B from memory 508B, to compute products, and/or dot products, of matrix 508A multiplied by matrix 508B. SD MPU 510B can input elements of matrix 508C from memory 508C, and elements of matrix 508D from memory 508D, to compute products, and/or dot products, of matrix 508C multiplied by matrix 508D.

As shown in FIG. 5, SD MPU 510A can output to SD MPU 510B, such as via output/input 518, products and/or dot products computed for matrix 508A multiplied by matrix 508B. The products can be a subset of products of matrix 508A multiplied by matrix 508B, and/or the dot products can be partial dot products (e.g., a sum of a subset of products) of matrix 508A multiplied by matrix 508B.

As SD MPU 510A outputs the products and/or dot products to SD MPU 510B, SD MPU 510B (e.g., SD MACC ALU 512B of SD MPU 510B) can receive the products/dot products via output/input 518 and can add the products/dot products received from SD MPU 510A to dot products computed by SD MPU 510B (and/or computed by another SD MPU, not shown in FIG. 5) to compute a dot product comprising products/dot products of matrix 508A multiplied by matrix 508B as computed by SD MPU 510A.

SD MPU 510A can output to SD MPU 510B products of matrix 508A multiplied by matrix 508B from, for example, a multiplier ALU, such as a multiplier ALU similar to multiplier ALU 216 of FIG. 2A. SD MPU 510A can output to SD MPU 510B dot products of matrix 508A multiplied by matrix 508A from, for example, an accumulator, such as an accumulator similar to ACC 220 of FIG. 2A. SD MPU 510A can output products/dot products of matrix 508A multiplied by matrix 508B to matrix C₀ in memory 516A, and SD MPU 510B can input, such as via output/input 518, output products/dot products of matrix 508A multiplied by matrix 508B from memory 516A.

SD MPU 510B can input the products/dot products and add these to products/dot products of optional matrix C₁ in memory 516B or, alternatively, to an accumulator of SD MPU 510B containing a dot product. The accumulator can comprise (accumulate) a sum of products/dot products computed by SD MPU 510B, computed by SD MPU 510A, and/or computed by another SD MPU of SDMP 500 not shown in FIG. 5. In implementations, SD MPUs 510 can output and/or input products and/or dot products, matrix 508A multiplied by matrix 508B, computed by SD MPU 510A, in any combination and/or order.

The examples of the disclosure are illustrated using two SD MPUs and two pairs of column- and row-split matrices for simplicity of the illustrations. However, these examples are not intended to limit implementations; as previously described, SDMP systems, and/or configurations of SDMP systems, can utilize a plurality of SD MPUs, and/or a plurality of SD split matrices, to perform SD-based matrix multiplication of parent matrices. Further, an SD MPU is not limited to outputting products/dot products to only one other SD MPU (and/or to one memory or storage element), nor is an SD MPU limited to receiving products/dot products from only one other SD MPU (and/or from one memory or storage element).

In implementations, an SD MPU can have a plurality of product/dot product outputs and/or inputs to output and/or input product/dot product outputs computed by other SD MPUs of an SDMP. Multiple SD MPUs can compute and/or output/input product/dot products in parallel. A single SD MPU can accumulate product/dot products of multiple other SD MPUs to compute a dot product of products/dot products output by multiple other SD MPUs.

Multiple SD MPUs can compute products/dot products of the same pairs of column- and row-split matrices. As one alternative to SD MPU 510A operating on matrix 508A and matrix 508B, and SD MPU 510B operating on matrix 508C and matrix 508D, as shown in FIG. 5, SD MPU 510A can, for example, compute products/dot products of one set of elements of matrix 508A and matrix 508B and SD MPU 510B can compute products/dot products of another set of elements of matrix 508A and matrix 508B. To illustrate in more detail, SD MPU 510A can, for example, compute products/dot products of elements of columns 1 to (K/4) of a row of matrix 508A and rows 1 to (K/4) of a column of matrix 508B, and SD MPU 510B compute products/dot products of elements of columns (K/4)+1 to K/2 of the row of matrix 508A and rows (K/4)+1 to K/2 of the column of matrix 508B. One of SD MPU 510A and SD MPU 510B can combine the products/dot product to compute a dot product of all K/2 elements of the row of matrix 508A and the column of matrix 508B.

While not shown in FIG. 5, in implementations SDMP 500 can comprise, and/or can be included in, a processor. For example, SDMP 500 can comprise a host processor, runtime processor, RDU, tiles of a RDU, and/or PCUs and/or PMUs of a tile or an RDS, such as illustrated in the examples of Grohoski and Kumar. SDMP 500 can be communicatively coupled to a processor, other SD MPUs, and/or other components of an SDMP and/or an RDS. It would be appreciated by one of ordinary skill in the art that an SD MPU, such as the example of SD MPU 200 in FIG. 2, and/or SD MPUs 510 in FIG. 5, can comprise, be incorporated into, or comprise any of a variety of computing systems and/or components of computing systems.

FIG. 5 illustrates SD MACC ALU 512A as included in SD MPU 510A, and SD MACC ALU 512B as included in SD MPU 510B. However, this is not intended to limit implementations and it would be appreciated by one of ordinary skill in the art that SD MACC ALU 512A and SD MACC ALU 512B can be MACC ALUs of the same SD MPU (e.g., SD MACC ALUs of one of SD MPU 510A or SD MPU 510B). In such a configuration, SD MACC ALU 512A and SD MACC ALU 512B can compute partial dot-products in parallel, and that SD MACC ALU 512A (for example) can output partial dot-products it computes based on matrix 508A and matrix 508B to SD MACC ALU 512B, and SD MACC ALU 512B can add partial dot-products output from SD MACC ALU 512A to partial dot-products computed by SD MACC ALU 512B based on matrix 508C and matrix 508D.

Additionally, or alternatively, as illustrated in FIG. 5, SD MACC ALU 512A can output partial dot-products to a memory, such as to matrix C₀ in memory 516A. Similarly, SD MACC ALU 512B can output partial dot-products to a memory, such as to matrix C₁ in memory 516B. SD MACC ALU 512B can input partial dot-products from matrix C₀ in memory 516A to add to partial dot-products computed by SD MACC ALU 512B. SD MACC ALU 512B can add partial dot-products input from matrix C₀, in memory 516A, to partial dot-products included in an accumulator of SD MACC ALU 512B and/or included in a memory, such as matrix C₁ in memory 516B.

Implementations can comprise a computer program product and can include a computer readable storage medium (or media) having computer readable program instructions of the computer program product incorporated therein. It will be understood by one of ordinary skill in the art that computer readable program instructions can implement each or any combination of operations and/or structure of the disclosure, such as illustrated by the drawings and described herein.

The computer readable program instructions can be provided to one or more processors, and/or other elements, of a computing system or apparatus to produce a machine which can execute, via the processor(s), to implement operations and/or actions similar or equivalent to those of the disclosure. The computer readable program instructions can be stored in a computer readable storage medium that can direct one or more processors, and/or other elements, of a computing system or apparatus to function in a particular manner, such that the computer readable storage medium comprises an article of manufacture including instructions to implement operations and/or structures similar or equivalent to those of the disclosure.

The computer readable program instructions of the computer program product can cause one or more processors to perform operations of the disclosure. A sequence of program instructions, and/or an assembly of one or more interrelated programming modules, of the computer program product can direct one or more one or more processors and/or computing elements of a computing system to implement the elements and/or operations of the disclosure including, but not limited to, the structures and operations illustrated and/or described in the present disclosure.

A computer readable storage medium can comprise any tangible (e.g., hardware) device, or combination of tangible devices, that can store instructions of the computer program product and that can be read by a computing element to download the instructions for use by a processor. A computer readable storage medium can comprise, but is not limited to, electronic, magnetic, optical, electromagnetic, and/or semiconductor storage devices, or any combination of these. A computer readable storage medium can comprise a portable storage medium, such as a magnetic disk/diskette, optical disk (CD or DVD); a volatile and/or non-volatile memory; a memory stick, a mechanically encoded device, and any combination of these. A computer readable storage medium, as used herein, is not to be construed as being transitory signals per se, such as electrical signals transmitted through a wire, radio waves or other freely propagating electromagnetic waves, or electromagnetic waves propagating through a wave transmission medium (e.g., a wave guide or fiber-optic cable).

The computer readable program instructions can be communicated from the computer readable storage medium to the one or more computing/processing devices, via a programming API of a computing system, and/or a communications interface of a computing system, having access to the computer readable storage medium, and/or a programming API of a computing system, and/or a communications interface of the one or more computing/processing devices. The API(s) and/or communications interface(s) can couple communicatively and/or operatively to a network, such as the Internet, a local area network, a wide area network, and/or a wireless network. The API(s) and/or communications interface(s) can receive the computer readable program instructions read from computer readable storage medium and can forward the computer readable program instructions to the one or more computing/processing devices via the API(s), communications interface(s), and/or network.

In implementations, the computer readable program instructions of the computer program product can comprise machine language and/or assembly language instructions, instruction-set-architecture (ISA) instructions, microcode and/or firmware instructions, state-setting data, configuration data for integrated circuitry, source code, and/or object code. The instructions and/or data can be written in any combination of one or more programming languages.

The computer readable program instructions can execute entirely, or in part, on a user's computer, as a stand-alone software package; partly on a user's computer and partly on a remote computer; or, entirely on a remote computer. A remote computer can be connected to a user's computer through any type of network, including a local area network (LAN) or a wide area network (WAN). In implementations, electronic circuitry including, for example, FPGA, PLAs, and or CGRPs can execute the computer readable program instructions by utilizing state information of the computer readable program instructions to configure the electronic circuitry to perform operations or elements of the disclosure, such as illustrated by the drawings and described herein.

In implementations, computer readable program instructions can also be loaded onto a computing system, or component(s) thereof, to cause the computing system and/or component(s) thereof to perform a series of operational steps to produce a computer implemented process, such that the instructions which execute on the computing system, or component(s) thereof, implement the operations or elements of the disclosure, such as illustrated by the drawings and described herein.

The flowchart and block diagrams in the Drawings and Incorporations illustrate the architecture, functionality, and operation of possible implementations of systems, methods, and computer program products according to various implementations of the present invention. Individual elements illustrated in the Figures—such as individual operations illustrated in the flowcharts or individual blocks of block diagrams—may represent a module, segment, or portion of executable instructions for implementing the disclosed function(s). In various alternative implementations, particular operations may occur in an order differing from that illustrated in the examples of the drawings. For example, two operations shown in succession in a diagram of the disclosure may, in a particular implementation, be executed substantially concurrently, or may sometimes be executed in a reverse order, depending upon the functionality involved. It will be further noted that particular blocks of the block diagrams, operations of the flowchart illustrations, and/or combinations of blocks in the block diagrams and/or flowchart illustrations, can be implemented using special purpose hardware and/or systems that, individually or in combination, perform the specified functions, acts, and/or computer instructions.

Terminology used herein, and the examples disclosed, are chosen to illustrate the principles of the implementations, the practical application or technical improvement over alternative technologies, and to enable others of ordinary skill in the art to understand the implementations disclosed herein. The disclosure illustrates various example implementations, and the examples are intended to illustrate principles and aspects of the disclosure, but are not intended to limit implementations, nor intended to be exhaustive of implementations that may be conceived within the scope of the disclosure. It would be apparent to one of ordinary skill in the art that alternative implementations can comprise modifications and combinations within the spirit of the disclosure and the scope of the claims.

As can be seen in the foregoing examples, features of the disclosure can comprise methods and apparati of computing systems. A summary of example implementations of such features includes:

### Example Implementation 1

A method comprises: determining, by a computing system, that a left hand matrix, comprising M number of rows and K number of columns, and a right hand matrix, comprising K number of rows and N number of columns, share dimension K;
generating, by the computing system, based on the determining that the left hand matrix and the right hand matrix share dimension K, a first column-split matrix and a second column-split matrix, the first column-split matrix comprising M number of rows and Q number of columns, rows 1 to M and columns 1 to Q of the first column-split matrix comprising respective rows 1 to M and columns 1 to Q of the left hand matrix, the second column-split matrix comprising M number of rows and P number of columns, rows 1 to M and columns 1 to P of the first column-split matrix comprising respective rows 1 to M and columns Q+1 to Q+P of the left hand matrix;
generating, by the computing system, based on the determining that the left hand matrix and the right hand matrix share dimension K, a first row-split matrix, and a second row-split matrix, the first row-split matrix comprising Q number of rows and N number of columns, columns 1 to N and rows 1 to Q of the first row-split matrix comprising respective columns 1 to N and rows 1 to Q of the right hand matrix, the second row-split matrix comprising P number of rows and N number of columns, columns 1 to N and rows Q+1 to Q+P of the second row-split matrix comprising respective columns 1 to N and rows Q+1 to Q+P of the right hand matrix;
computing, by a first matrix processing unit (MPU) of the computing system, a first partial dot product comprising products of a row of the first column-split matrix multiplied by a column of the first row-split matrix; computing, by a second MPU of the computing system, concurrent with the first MPU computing the first partial dot product, a second partial dot product comprising products of a row of the second column-split matrix multiplied by a column of the second row-split matrix; and, computing, by a third MPU of the computing system, a dot product comprising a sum of the first partial dot product and the second partial dot product.

### Example Implementation 2

Example implementation 1, wherein the dot product comprises a complete dot product.

### Example Embodiment 3

Example implementation 1, wherein the first MPU and the second MPU comprise different MPUs.

### Example Embodiment 4

Example implementation 1, wherein P is numerically less than Q; wherein the method of the computing system generating the second column-split matrix comprises generating, by the computing system, the second column-split matrix comprising P minus Q number of columns, columns (P+1) to Q of the second column-split matrix comprising all zeros; wherein the method of the computing system generating the second row-split matrix comprises generating, by the computing system, the second row-split matrix comprising P minus Q number of row, rows (P+1) to Q of the second row-split matrix comprising all zeros; and, wherein the method of the second MPU computing the second partial dot product comprises computing, by the second MPU, products of elements among columns (P+1) to Q of the row of the second column-split matrix multiplied by respective elements among row (P+1) to Q of the column of the second row-split matrix.

### Example Embodiment 5

Example implementation 1, wherein P is numerically less than Q; and,
wherein the method of the second MPU computing the second partial dot product comprises the second MPU computing a (P+1) product as a value of zero and adding the (P+1) product to products among products included in the second partial dot product.

### Example Embodiment 6

Example implementation 1, wherein the method of the first MPU computing the first partial dot product comprises the first MPU computing the first partial dot product as a multiply-accumulate (MACC) computation.

### Example Embodiment 7

Example implementation 6, wherein the MACC computation comprises adding, by the first MPU, the products of the row of the first column-split matrix multiplied by the column of the first row-split matrix, to an accumulator.

### Example Embodiment 8

Example implementation 7, wherein the method of the second MPU computing the second partial dot product comprises adding, by the second MPU, an output of the accumulator to the second partial dot product.

### Example Embodiment 9

An example computer program product comprises a computer readable storage medium having program instructions embodied therewith, wherein the program instructions are executable by at least one processor to cause the at least one processor to:
determine that a left hand matrix, comprising M number of rows and K number of columns, and a right hand matrix, comprising K number of rows and N number of columns, share dimension K; generate, based on the determining that the left hand matrix and the right hand matrix share dimension K, a first column-split matrix and a second column-split matrix, the first column-split matrix comprising M number of rows and Q number of columns, rows 1 to M and columns 1 to Q of the first column-split matrix comprising respective rows 1 to M and columns 1 to Q of the left hand matrix, the second column-split matrix comprising M number of rows and P number of columns, rows 1 to M and columns 1 to P of the first column-split matrix comprising respective rows 1 to M and columns Q+1 to Q+P of the left hand matrix,
generate, based on the determining that the left hand matrix and the right hand matrix share dimension K, a first row-split matrix, and a second row-split matrix, the first row-split matrix comprising Q number of rows and N number of columns, columns 1 to N and rows 1 to Q of the first row-split matrix comprising respective columns 1 to N and rows 1 to Q of the right hand matrix, the second row-split matrix comprising P number of rows and N number of columns, columns 1 to N and rows Q+1 to Q+P of the second row-split matrix comprising respective columns 1 to N and rows Q+1 to Q+P of the right hand matrix;
compute a first partial dot product comprising products of a row of the first column-split matrix multiplied by a column of the first row-split matrix; compute, concurrent with the computing the first partial dot product, a second partial dot product comprising products of a row of the second column-split matrix multiplied by a column of the second row-split matrix; and, compute a dot product comprising a sum of the first partial dot product and the second partial dot product.

### Example Embodiment 10

Example implementation 9, wherein P is numerically less than Q; and,
wherein the program instructions are executable by the at least one processor to further cause the at least one processor to: generate the second column-split matrix comprising P minus Q number of columns, columns (P+1) to Q of the second column-split matrix comprising all zeros; generate the second row-split matrix comprising P minus Q number of row, rows (P+1) to Q of the second row-split matrix comprising all zeros; and, compute the second partial dot product by computing products of elements among columns (P+1) to Q of the row of the second column-split matrix multiplied by respective elements among row (P+1) to Q of the column of the second row-split matrix.

### Example Embodiment 11

An example computing system, the system comprising: a plurality of matrix compute units (MPUs), and a Shared Dimension (SD) splitter; the SD splitter configured to: determine that a left hand matrix, comprising M number of rows and K number of columns, and a right hand matrix, comprising K number of rows and N number of columns, share dimension K;
generate, based on the determining that the left hand matrix and the right hand matrix share dimension K, a first column-split matrix and a second column-split matrix, the first column-split matrix comprising M number of rows and Q number of columns, rows 1 to M and columns 1 to Q of the first column-split matrix comprising respective rows 1 to M and columns 1 to Q of the left hand matrix, the second column-split matrix comprising M number of rows and P number of columns, rows 1 to M and columns 1 to P of the first column-split matrix comprising respective rows 1 to M and columns Q+1 to Q+P of the left hand matrix,
generate, based on the determining that the left hand matrix and the right hand matrix share dimension K, a first row-split matrix, and a second row-split matrix, the first row-split matrix comprising Q number of rows and N number of columns, columns 1 to N and rows 1 to Q of the first row-split matrix comprising respective columns 1 to N and rows 1 to Q of the right hand matrix, the second row-split matrix comprising P number of rows and N number of columns, columns 1 to N and rows Q+1 to Q+P of the second row-split matrix comprising respective columns 1 to N and rows Q+1 to Q+P of the right hand matrix;
wherein a first MPU among the plurality of MPUs is configured to compute a first partial dot product comprising products of a row of the first column-split matrix multiplied by a column of the first row-split matrix; wherein a second MPU among the plurality of MPUs is configured to compute, concurrent with the first MPU computing the first partial dot product, a second partial dot product comprising products of a row of the second column-split matrix multiplied by a column of the second row-split matrix; and, wherein a third MPU among the plurality of MPUs is configured to compute a dot product comprising a sum of the first partial dot product and the second partial dot product.

### Example Embodiment 12

Example implementation 11, wherein the dot product comprises a complete dot product.

### Example Embodiment 13

Example implementation 11, wherein the first MPU and the second MPU comprise different MPUs.

### Example Embodiment 14

Example implementation 13, wherein the first MPU is further configured to output the first partial dot product to the second MPU; and, wherein the second MPU configured to compute the second partial dot product comprises the second MPU further configured to add the first partial dot product to the products among the products of the row of the second column-split matrix multiplied by the column of the second row-split matrix.

### Example Embodiment 15

Example implementation 11, wherein P is numerically less than Q; wherein the SD splitter configured to generate the second column-split matrix comprises the SD splitter further configured to generate the second column-split matrix comprising P minus Q number of columns, columns (P+1) to Q of the second column-split matrix comprising all zeros; wherein the SD splitter configured to generate the second row-split matrix comprises the SD splitter further configured to generate the second row-split matrix comprising P minus Q number the SD splitter configured to generate of row, rows (P+1) to Q of the second row-split matrix comprising all zeros; and, wherein the SD splitter configured to compute the second partial dot product comprises the SD splitter configured to compute products of elements among columns (P+1) to Q of the row of the second column-split matrix multiplied by respective elements among row (P+1) to Q of the column of the second row-split matrix.

### Example Embodiment 16

Example implementation 11, wherein P is numerically less than Q; and, wherein the second MPU configured to compute the second partial dot product comprises the second MPU further configured to compute a (P+1) product as a value of zero and adding the (P+1) product to products among products included in the second partial dot product.

### Example Embodiment 17

Example implementation 11, wherein the first MPU comprises a multiply-accumulate arithmetic logic unit; and, wherein the first MPU configured to compute the first partial dot product comprises the multiply-accumulate arithmetic logic unit configured to compute the first partial dot product as a multiply-accumulate computation.

### Example Embodiment 18

Example implementation 17, wherein the multiply-accumulate arithmetic logic unit comprises an accumulator; and, wherein the multiply-accumulate arithmetic logic unit configured to compute the first partial dot product as a multiply-accumulate computation comprises the multiply-accumulate arithmetic logic unit configured to: compute a product of a column element of the row of the first column-split matrix and a corresponding row element of the column of the first column-split matrix; compute the first partial dot product a sum of the product and a fist value of the accumulator; and, store the first partial dot product in the accumulator.

### Example Embodiment 19

Example implementation 11, wherein at least one of the first MPU, the second MPU, and the third MPU comprise more than one MPU among the plurality of MPUs.

### Example Embodiment 20

Example implementation 11, wherein at least one of the first MPU, the second MPU, and the third MPU comprise a reconfigurable dataflow unit.

### Example Embodiment 21

An example method comprises: receiving, by a first Multiply-Accumulate (MACC) Arithmetic Logic Unit (ALU) included in a Matrix Processing Unit (MPU) of a computing system, based on a left side matrix and a right side matrix having a shared dimension, column elements of a row of a first column-split matrix and row elements of a column of a first row-split matrix, the left side matrix comprising the shared dimension number of columns and the right side matrix comprising the shared dimension number of rows, the first column-split matrix comprising a first number of columns among columns of a left side matrix, the first row-split matrix comprising the first number of rows among rows of a right side matrix; and, receiving, by a second MACC ALU included in the MPU, based on the left side matrix and the right side matrix having the shared dimension, column elements of a row of a second column-split matrix and row elements of a column of a second row-split matrix, the second column-split matrix comprising a second number of columns among the shared dimension number of columns of the left side matrix, the second row-split matrix comprising the second number of rows among the shared dimension number of rows of the right side matrix.

The method further comprises computing, by the first MACC ALU, a first partial dot product comprising a sum of first row-column products, the first row-column products comprising products of elements among the column elements of the row of the first column-split matrix multiplied by corresponding elements among the row elements of the column of the first row-split matrix; computing, by the second MACC ALU, concurrent with the first MACC ALU computing the first partial dot product, a second partial dot product, the second partial dot product comprising a sum of second row-column products, the second row-column products comprising products of elements among the column elements of the row of the second column-split matrix multiplied by corresponding elements among the row elements of the column of the second row-split matrix; and, computing, by the second MACC ALU, a dot product comprising a sum of the first partial dot product and the second partial dot product.

### Example Embodiment 22

Example implementation 21, wherein the method further comprises outputting, by the first MACC ALU, the first partial dot product to a memory; and, wherein the method of the second MACC ALU computing the dot product comprises inputting, by the second MACC ALU, the first partial dot product from the memory.

### Example Embodiment 23

Example implementation 21, wherein the method of the second MACC ALU computing the sum of the first partial dot product and the second partial dot product comprises: inputting, by the second MACC ALU, to an adder ALU, the first partial dot product; and, adding, by the adder ALU, the first partial dot product and the second partial dot product.

### Example Embodiment 24

Example implementation 23, wherein the method of the adder ALU adding the first partial dot product and the second partial dot product comprises the adder ALU adding the first partial dot product and the second partial dot product to a first accumulator.

### Example Embodiment 25

Example implementation 24, wherein the method of the first MACC ALU computing the first partial dot product comprises adding, by the first MACC ALU, the first row-column products to a second accumulator; wherein the method of the second MACC ALU inputting, to the adder ALU, the first partial dot product comprises inputting, by the second MACC ALU, a value of the second accumulator; and, wherein the method of the adder ALU adding the first partial dot product to the first accumulator further comprises adding, by the adder ALU, the value of the second accumulator to the first accumulator.

### Example Embodiment 26

Example implementation 21, wherein the first number of columns is greater than the second number; wherein, based on the first number greater than the second number, the second column-split matrix further comprises an all-zeros column, each element of the all-zeros column having value zero; wherein, based on the first number greater than the second number, the second row-split matrix further comprises an all-zeros row, each element of the all-zeros row having the value zero; and, wherein the method of the second MACC ALU computing the second partial dot product comprises the second MACC ALU adding, to the second partial dot product, a product of a row element of the all-zeros column of the second column-split matrix multiplied by a row element of the all-zeros row of the second row-split matrix.

### Example Embodiment 27

Example implementation 21, wherein the first number is greater than the second number; and, wherein the method of the second MACC ALU computing the second partial dot product comprises the second MACC ALU adding to the second partial dot product, based on the first number greater than the second number, a value of zero.

### Example Embodiment 28

Example implementation 21, wherein the method of the first MACC ALU computing the first partial dot product further comprises the first MACC ALU computing the first partial dot product as a MACC computation.

### Example Embodiment 29

An example Matrix Processing Unit (MPU) in a computing system computing system comprises a first Multiply-Accumulate (MACC) Arithmetic Logic Unit (ALU); a second MACC ALU; and, a first adder ALU.

The first MACC ALU is configured to: receive, based on a left side matrix and a right side matrix having a shared dimension, column elements of a row of a first column-split matrix and row elements of a column of a first row-split matrix, the first column-split matrix comprising a first number of columns among columns of a left side matrix, the first row-split matrix comprising the first number of rows among rows of a right side matrix, the left side matrix and a right side matrix having the shared dimension, the left side matrix comprising the shared dimension number of columns and the right side matrix comprising the shared dimension number of rows; and, compute a first partial dot product comprising a sum of first row-column products, the first row-column products comprising products of column elements of a row of the first column-split matrix multiplied by corresponding row elements of a column of the first row-split matrix.

The second MACC ALU is configured to: receive, based on the left side matrix and the right side matrix having the shared dimension, column elements of a row of a second column-split matrix and row elements of a column of a second row-split matrix, the second column-split matrix comprising a second number of columns among the shared dimension number of columns of the left side matrix, the second row-split matrix comprising the second number of rows among the shared dimension number of rows of the right side matrix; and, compute, concurrent with the first MACC ALU computing the first partial dot product, a second partial dot product comprising products of a sum of second row-column products, the second row-column products comprising column elements of a row of the second column-split matrix multiplied by corresponding row elements of a column of the second row-split matrix.

The first adder ALU is configured to: input the first partial dot product and the second partial dot product; and, compute a dot product comprising a sum of the first partial dot product and the second partial dot product.

### Example Embodiment 30

Example implementation 29, wherein the MPU further comprises a third MACC ALU; wherein the third MACC ALU comprises the first adder ALU; wherein the first MACC ALU is configured to output the first partial dot product to the third MACC ALU; and, wherein the first adder ALU configured to compute the sum of the first partial dot product and the second partial dot product comprises the first adder ALU further configured to add the first partial dot product output from the first MACC ALU to the second partial dot product.

### Example Embodiment 31

Example implementation 30, wherein the third MACC ALU comprises an accumulator; and wherein the first adder ALU configured to add the first partial dot product, output from the first MACC ALU, to the second partial dot product comprises the first adder ALU further configured to add the first partial dot product, output from the first MACC ALU to the accumulator.

### Example Embodiment 32

Example implementation 29, wherein the first number is greater than the second number; wherein, based on the first number greater than the second number, the second column-split matrix further comprises an all-zeros column, each element of the all-zeros column having value zero; wherein, based on the first number greater than the second number, the second row-split matrix further comprises an all-zeros row, each element of the all-zeros row having the value zero; and, wherein the second MACC ALU configured to compute the second partial dot product comprises the second MACC ALU further configured to add to the second partial dot product, based on the first number greater than the second number, a product of a row element of the all-zeros column of the second column-split matrix multiplied by a column element of the all-zeros row of the second row-split matrix.

### Example Embodiment 33

Example implementation 32, wherein the computing system comprises a first memory and a second memory; and, wherein the MPU further comprises read logic configured to: input, to the second MACC ALU, from the first memory, the row element of the all-zeros column of the second column-split matrix; and, input, to the second MACC ALU, from the second memory, the column element of the all-zeros row of the second row-split matrix.

### Example Embodiment 34

Example implementation 29, wherein the first number is greater than the second number; and, wherein the second MACC ALU configured to compute the second partial dot product comprises the second MACC ALU further configured to add, based on the first number greater than the second number, a value of zero to the second partial dot product.

### Example Embodiment 35

Example implementation 29, wherein the first MACC ALU is configured to output, to a first memory, the first partial dot product; wherein the second MACC ALU is configured to output, to a second memory, the second partial dot product; wherein the first adder ALU configured to add the first partial dot product to the second partial dot product comprises the first adder ALU further configured to: input the first partial dot product, from the first memory; and, input the second partial dot product from the second memory.

### Example Embodiment 36

Example implementation 29, wherein the first MACC ALU comprises a multiplier ALU and a second adder ALU; wherein the first MACC ALU is further configured to input, to the multiplier ALU, a first column element, a second column element, a first row element, and a second row element, the first column element and the second column element among the column elements of the row of the first column-split matrix, the first row element and the second row element among the corresponding row elements of the column of the first column-split matrix.

The multiplier ALU is configured to: compute a first product comprising the first column element multiplied by the first row element and output, to the first adder ALU, the first product; and, compute a second product comprising the second column element multiplied by the second row element and output, to the first adder ALU, the second product. The first MACC ALU configured to compute the sum of the first row-column products comprises the second adder ALU configured to compute a sum of the first product and the second product.

### Example Embodiment 37

Example implementation 36, wherein the first MACC ALU further comprises a first accumulator; and, wherein the second adder ALU configured to add the first product and the second product comprises the second adder ALU further configured to add the first product to the first accumulator and add the second product to the first accumulator.

### Example Embodiment 38

Example implementation 37, wherein the MPU comprises a third MACC ALU;

wherein the third MACC ALU comprises the first adder ALU and a second accumulator; and, wherein the first adder ALU configured to receive, from the first MACC ALU, the first partial dot product comprises the first adder ALU further configured to receive the first partial dot product from the first accumulator.

### Example Embodiment 39

Example implementation 38, wherein the third MACC ALU further comprises a second accumulator; and, wherein the first adder ALU configured to compute the sum of the first partial dot product and the second partial dot product comprises the first adder ALU further configured to add the first partial dot product and the second partial dot product to the second accumulator.

### Example Embodiment 40

Example implementation 29, wherein the MPU comprises a reconfigurable dataflow unit.

What is claimed is:

1. A method, the method comprising:
receiving, by a first Multiply-Accumulate (MACC) Arithmetic Logic Unit (ALU) included in a Matrix Processing Unit (MPU) of a computing system, based on a left side matrix and a right side matrix having a shared dimension number, column elements of a row of a first column-split matrix and row elements of a column of a first row-split matrix, the left side matrix comprising the shared dimension number of columns and the right side matrix comprising the shared dimension number of rows, the first column-split matrix comprising a first number of columns among columns of a left side matrix, the first row-split matrix comprising the first number of rows among rows of a right side matrix;
receiving, by a second MACC ALU included in the MPU, based on the left side matrix and the right side matrix having the shared dimension, column elements of a row of a second column-split matrix and row elements of a column of a second row-split matrix, the second column-split matrix comprising a second number of columns among the shared dimension number of columns of the left side matrix, the second row-split matrix comprising the second number of rows among the shared dimension number of rows of the right side matrix;
computing, by the first MACC ALU, a first partial dot product comprising a sum of first row-column products, the first row-column products comprising products of elements among the column elements of the row of the first column-split matrix multiplied by corresponding elements among the row elements of the column of the first row-split matrix;
computing, by the second MACC ALU, concurrent with the first MACC ALU computing the first partial dot product, a second partial dot product, the second partial dot product comprising a sum of second row-column products, the second row-column products comprising products of elements among the column elements of the row of the second column-split matrix multiplied by corresponding elements among the row elements of the column of the second row-split matrix; and,
computing, by the second MACC ALU, a dot product comprising a sum of the first partial dot product and the second partial dot product.

2. The method of claim 1, wherein the method further comprises outputting, by the first MACC ALU, the first partial dot product to a memory; and,
wherein the method of the second MACC ALU computing the dot product comprises inputting, by the second MACC ALU, the first partial dot product from the memory.

3. The method of claim 1, wherein the method of the second MACC ALU computing the sum of the first partial dot product and the second partial dot product comprises:
inputting, by the second MACC ALU, to an adder ALU, the first partial dot product; and,
adding, by the adder ALU, the first partial dot product and the second partial dot product.

4. The method of claim 3, wherein the method of the adder ALU adding the first partial dot product and the second partial dot product comprises the adder ALU adding the first partial dot product and the second partial dot product to a first accumulator.

5. The method of claim 4, wherein the method of the first MACC ALU computing the first partial dot product comprises adding, by the first MACC ALU, the first row-column products to a second accumulator;
wherein the method of the second MACC ALU inputting, to the adder ALU, the first partial dot product comprises inputting, by the second MACC ALU, a value of the second accumulator; and,
wherein the method of the adder ALU adding the first partial dot product to the first accumulator further comprises adding, by the adder ALU, the value of the second accumulator to the first accumulator.

6. The method of claim 1, wherein the first number of columns is greater than the second number;
wherein, based on the first number greater than the second number, the second column-split matrix further comprises an all-zeros column, each element of the all-zeros column having value zero;
wherein, based on the first number greater than the second number, the second row-split matrix further comprises an all-zeros row, each element of the all-zeros row having the value zero; and,
wherein the method of the second MACC ALU computing the second partial dot product comprises the second MACC ALU adding, to the second partial dot product, a product of a row element of the all-zeros column of the second column-split matrix multiplied by a row element of the all-zeros row of the second row-split matrix.

7. The method of claim 1, wherein the first number is greater than the second number; and, wherein the method of the second MACC ALU computing the second partial dot product comprises the second MACC ALU adding to the second partial dot product, based on the first number greater than the second number, a value of zero.

8. The method of claim 1, wherein the method of the first MACC ALU computing the first partial dot product further comprises the first MACC ALU computing the first partial dot product as a MACC computation.

9. A Matrix Processing Unit (MPU) included in a computing system, the MPU comprising:
a first Multiply-Accumulate (MACC) Arithmetic Logic Unit (ALU); a second MACC ALU; and,
a first adder ALU,
wherein the first MACC ALU is configured to:
receive, based on a left side matrix and a right side matrix having a shared dimension, number column elements of a row of a first column-split matrix and row elements of a column of a first row-split matrix, the left side matrix comprising the shared dimension number of columns and the right side matrix comprising the shared dimension number of rows, the first column-split matrix comprising a first number of columns among columns of a left side matrix, the first row-split matrix comprising the first number of rows among rows of a right side matrix; and,
compute a first partial dot product comprising a sum of first row-column products, the first row-column products comprising products of column elements of a row of the first column-split matrix multiplied by corresponding row elements of a column of the first row-split matrix;
wherein the second MACC ALU is configured to:
receive, based on the left side matrix and the right side matrix having the shared dimension, column elements of a row of a second column-split matrix and row elements of a column of a second row-split matrix, the second column-split matrix comprising a second number of columns among the shared dimension number of columns of the left side matrix, the second row-split matrix comprising the second number of rows among the shared dimension number of rows of the right side matrix; and,
compute, concurrent with the first MACC ALU computing the first partial dot product, a second partial dot product comprising products of a sum of second row-column products, the second row-column products comprising column elements of a row of the second column-split matrix multiplied by corresponding row elements of a column of the second row-split matrix; and,
wherein the first adder ALU is configured to:
input the first partial dot product and the second partial dot product; and,
compute a dot product comprising a sum of the first partial dot product and the second partial dot product.

10. The MPU of claim 9, wherein the MPU further comprises a third MACC ALU;
wherein the third MACC ALU comprises the first adder ALU;
wherein the first MACC ALU is configured to output the first partial dot product to the third MACC ALU; and,
wherein the first adder ALU configured to compute the sum of the first partial dot product and the second partial dot product comprises the first adder ALU further configured to add the first partial dot product output from the first MACC ALU to the second partial dot product.

11. The MPU of claim 10, wherein the third MACC ALU comprises an accumulator; and
wherein the first adder ALU configured to add the first partial dot product, output from the first MACC ALU, to the second partial dot product comprises the first adder ALU further configured to add the first partial dot product, output from the first MACC ALU to the accumulator.

12. The MPU of claim 9, wherein the first number is greater than the second number;
wherein, based on the first number greater than the second number, the second column-split matrix further comprises an all-zeros column, each element of the all-zeros column having value zero;
wherein, based on the first number greater than the second number, the second row-split matrix further comprises an all-zeros row, each element of the all-zeros row having the value zero; and,
wherein the second MACC ALU configured to compute the second partial dot product comprises the second MACC ALU further configured to add to the second partial dot product, based on the first number greater than the second number, a product of a row element of the all-zeros column of the second column-split matrix multiplied by a column element of the all-zeros row of the second row-split matrix.

13. The MPU of claim 12, wherein the computing system comprises a first memory and a second memory; and,
wherein the MPU further comprises read logic configured to:
input, to the second MACC ALU, from the first memory, the row element of the all-zeros column of the second column-split matrix; and,
input, to the second MACC ALU, from the second memory, the column element of the all-zeros row of the second row-split matrix.

14. The MPU of claim 9, wherein the first number is greater than the second number; and,
wherein the second MACC ALU configured to compute the second partial dot product comprises the second MACC ALU further configured to add, based on the first number greater than the second number, a value of zero to the second partial dot product.

15. The MPU of claim 9, wherein the first MACC ALU is configured to output, to a first memory, the first partial dot product;
wherein the second MACC ALU is configured to output, to a second memory, the second partial dot product;
wherein the first adder ALU configured to add the first partial dot product to the second partial dot product comprises the first adder ALU further configured to:
input the first partial dot product, from the first memory; and,
input the second partial dot product from the second memory.

16. The MPU of claim 9, wherein the first MACC ALU comprises a multiplier ALU and a second adder ALU;
wherein the first MACC ALU is further configured to input, to the multiplier ALU, a first column element, a second column element, a first row element, and a second row element, the first column element and the second column element among the column elements of the row of the first column-split matrix, the first row element and the second row element among the corresponding row elements of the column of the first column-split matrix;
wherein the multiplier ALU is configured to:
compute a first product comprising the first column element multiplied by the first row element and output, to the first adder ALU, the first product; and,
compute a second product comprising the second column element multiplied by the second row element and output, to the first adder ALU, the second product; and,
wherein the first MACC ALU configured to compute the sum of the first row-column products comprises the second adder ALU configured to compute a sum of the first product and the second product.

17. The MPU of claim 16, wherein the first MACC ALU further comprises a first accumulator; and,
wherein the second adder ALU configured to add the first product and the second product comprises the second adder ALU further configured to add the first product to the first accumulator and add the second product to the first accumulator.

18. The MPU of claim 17, wherein the MPU comprises a third MACC ALU;
wherein the third MACC ALU comprises the first adder ALU and a second accumulator; and,
wherein the first adder ALU configured to receive, from the first MACC ALU, the first partial dot product comprises the first adder ALU further configured to receive the first partial dot product from the first accumulator.

19. The MPU of claim 18, wherein the third MACC ALU further comprises a second accumulator; and,
wherein the first adder ALU configured to compute the sum of the first partial dot product and the second partial dot product comprises the first adder ALU further configured to add the first partial dot product and the second partial dot product to the second accumulator.

20. The MPU of claim 9, wherein the MPU comprises a reconfigurable dataflow unit.
